(19) United States
(12) Patent Application Publication
(10) Pub. No.: US 2016/0353064 A1
(43) Pub. Date: Dec. 1, 2016

(54) VIDEO MONITORING SYSTEM AND VIDEO MONITORING METHOD

(71) Applicant: MITSUBISHI ELECTRIC CORPORATION, Tokyo (JP)

(72) Inventor: Toshiharu AIURA, Tokyo (JP)

(73) Assignee: MITSUBISHI ELECTRIC CORPORATION, Tokyo (JP)

(21) Appl. No.: 15/117,412

(22) PCT Filed: Jun. 6, 2014
(86) PCT No.: PCT/JP2014/065159

§ 371 Date: Aug. 8, 2016

(51) Int. Cl. H04N 7/18; G08B 13/196; G06K 9/46

(52) U.S. Cl. CPC H04N 7/181; G06K 9/4604; G08B 13/19693

(57) ABSTRACT

A reception unit of a video monitoring system receives imaged video from a plurality of monitor cameras, each of which images video of a corresponding region among imaging regions a to d in a certain place P. A control unit of the video monitoring system performs control to display the video received by the reception unit on a screen. An operation unit of the video monitoring system receives an operation for specifying the imaging regions b and d. When the video of the imaging regions a to d is displayed on the screen by the control unit, an instruction unit of the video monitoring system instructs the plurality of monitor cameras to transmit the imaged video in a first format. When the video of the imaging regions b and d is displayed on the screen by the control unit, the instruction unit instructs the monitor cameras which image the video of the imaging regions b and d to transmit the imaged video in a second format which has a larger data amount than the first format.

### TECHNICAL FIELD

The present invention relates to a video monitoring system and a video monitoring method.

### BACKGROUND ART

In a video monitoring system for using a plurality of monitor cameras, there is a method in which a monitoring person obtains entire video of a building or site to be monitored (for example, refer to Patent Literature 1 and Non Patent Literature 1).

In Patent Literature 1, a method has been proposed for managing the video imaged by the plurality of monitor cameras and information on a place where the monitor camera is placed, synthesizing video of the monitoring cameras adjacent to each other, and creating video for looking down a room or floor or a building from right above. The system in Patent Literature 1 includes a plurality of servers in the building and a monitoring server. Each server in the building creates a synthesized image from the video of the monitor cameras adjacent to each other based on the information on the place where the monitor camera is placed. The monitoring server receives the synthesized image created by the plurality of servers in the building as an input and generates overhead view video for looking down the whole floor from above. The monitoring server creates the overhead view video of the whole building from the overhead view video of each floor. According to this, the overhead view video of the whole building is provided to the monitoring person.

In Non Patent Literature 1, a method has been proposed for imaging video of a place near a platform fence of a station by monitor cameras and displaying the video for looking down the place from right above by converting view points of the imaged video. The system in Non Patent Literature 1 includes a control terminal and a display terminal. The control terminal converts the view points of the video and performs trimming to the video imaged by the monitor cameras placed along the platform fence of the station. The display terminal receives the video after the view point conversion by the control terminal as an input and creates a layout in which the video imaged by adjacent monitor cameras is displayed next to each other. According to this, overhead view video of a boundary between the platform and a train is provided to a station staff and a railway crew.

### CITATION LIST

### Patent Literature

Patent Literature 1: JP 2008-118466 A

### Non Patent Literature

Non Patent Literature 1: KAWABE Keiichi, EGAMI Tsukasa, and NAKAYAMA Toshihiro, “Top view monitor system”, Japan Railway Engineers' Association, November, 2013, No. 407

### SUMMARY OF INVENTION

### Technical Problem

When a conventional system for providing overhead view video is applied to a large facility, a network band between a monitor camera and a calculator for performing image processing (for example, view point conversion) lacks. Therefore, it is necessary to introduce a plurality of the servers in the building in Patent Literature 1 and a plurality of the control terminals in Non Patent Literature 1 and divide them into network segments.

For example, Non Patent Literature 1 discloses that the resolution of a moving image to be used is 1920×1080 and the frame rate is 30 frames per second (fps). In Patent Literature 1, a specification of the moving image to be used is not described. However, when it is assumed that the monitor camera has a performance of a standard monitor camera which is currently available in the market, it is assumed that a camera which has similar performance to that in Non Patent Literature 1 is used. Further, Non Patent Literature 1 discloses that the monitor camera is connected to the control terminal with the Ethernet (registered trademark). When the moving image is transmitted from the monitor camera to the server in the building in Patent Literature 1 or the control terminal in Non Patent Literature 1 by using the Ethernet (registered trademark) of 1 gigabits per second (Gbps) band which is currently used in the market, it is necessary to construct the network segment in which the number of monitor cameras is about 100. In a general monitor camera system, the monitor camera constantly outputs video data to be recorded in addition to the video data to be displayed. Therefore, the number of monitor cameras which can be connected to the single network segment is about several dozen in reality.

When the overhead view video is created in a station having a commercial facility or a large shopping center in the metropolitan area, it is necessary to place more than thousands of monitor cameras. Therefore, it is necessary to construct equal to or more than 100 network segments. That is, as described above, the plurality of servers in the building in Patent Literature 1 or the plurality of control terminals in Non Patent Literature 1 is needed, and there are various problems such as complication of management and an increase in cost.

An object of the present invention is, for example, to reduce a communication band necessary for transmitting video imaged by a plurality of monitor cameras without disrupting video monitoring operation.

### Solution to Problem

A video monitoring system according to one aspect of the present invention includes:

a reception unit to receive imaged video from a plurality of monitor cameras, each of which images video of a corresponding region among a plurality of regions in a certain place;

a control unit to perform control to display the video received by the reception unit on a screen;

an operation unit to receive an operation for specifying a limited region among the plurality of regions; and

an instruction unit to instruct the plurality of monitor cameras to transmit the imaged video in a first format when video of the plurality of regions is displayed on the screen by the control unit and instruct a monitor camera which images video of the region specified to the operation unit to transmit the imaged video in a second format which has a larger data amount than the first format when the video of the specified region is displayed on the screen by the control unit.

### Advantageous Effects of Invention

In the present invention, when video of a plurality of regions is displayed, video with lower quality than that in a case where video of a limited region is displayed is received from a monitor camera. Therefore, according to the present invention, a communication band necessary for transmitting the video imaged by a plurality of monitor cameras can be reduced without disrupting video monitoring operation.

### BRIEF DESCRIPTION OF DRAWINGS

FIG. 1 is a block diagram of a structure of a video monitoring system according to a first embodiment.

FIG. 2 is a block diagram of a structure of a control server of the video monitoring system according to the first embodiment.

FIG. 3 is a block diagram of a structure of a display server of the video monitoring system according to the first embodiment.

FIG. 4 is a diagram of an application of the video monitoring system according to the first embodiment.

FIG. 5 is a diagram of an exemplary screen display of the display server of the video monitoring system according to the first embodiment and that according to a second embodiment.

FIG. 6 is a diagram of another exemplary screen display of the display server of the video monitoring system according to the first and second embodiments.

FIG. 7 is a flowchart of an exemplary operation of the display server of the video monitoring system according to the first embodiment.

FIG. 8 is a flowchart of an exemplary operation of the control server of the video monitoring system according to the first embodiment.

FIG. 9 is a flowchart of an exemplary operation of the control server of the video monitoring system according to the first embodiment.

FIG. 10 is a flowchart of an exemplary operation of the control server of the video monitoring system according to the first embodiment.

FIG. 11 is a flowchart of an exemplary operation of the display server of the video monitoring system according to the first embodiment.

FIG. 12 is a block diagram of a structure of a video monitoring system according to the second embodiment and a third embodiment.

FIG. 13 is a block diagram of a structure of a monitor camera of the video monitoring system according to the second embodiment.

FIG. 14 is a block diagram of a structure of a display server of the video monitoring system according to the second embodiment.

FIG. 15 is a diagram of an application of the video monitoring system according to the second and third embodiments.

FIG. 16 is a flowchart of an exemplary operation of the display server of the video monitoring system according to the second embodiment.

FIG. 17 is a flowchart of an exemplary operation of the monitor camera of the video monitoring system according to the second embodiment.

FIG. 18 is a flowchart of an exemplary operation of the monitor camera of the video monitoring system according to the second embodiment.

FIG. 19 is a flowchart of an exemplary operation of the monitor camera of the video monitoring system according to the second embodiment.

FIG. 20 is a flowchart of an exemplary operation of the display server of the video monitoring system according to the second embodiment.

FIG. 21 is a block diagram of a structure of a monitor camera of the video monitoring system according to the third embodiment.

FIG. 22 is a block diagram of a structure of a display server of the video monitoring system according to the third embodiment.

FIG. 23 is a diagram of an exemplary screen display of the display server of the video monitoring system according to the third embodiment.

FIG. 24 is a flowchart of an exemplary operation of the display server of the video monitoring system according to the third embodiment.

FIG. 25 is a flowchart of an exemplary operation of the monitor camera of the video monitoring system according to the third embodiment.

FIG. 26 is a flowchart of an exemplary operation of the monitor camera of the video monitoring system according to the third embodiment.

FIG. 27 is a flowchart of an exemplary operation of the monitor camera of the video monitoring system according to the third embodiment.

FIG. 28 is a flowchart of an exemplary operation of the display server of the video monitoring system according to the third embodiment.

FIG. 29 is a flowchart of an exemplary operation of the display server of the video monitoring system according to the third embodiment.

FIG. 30 is a diagram of an exemplary hardware structure of each device of the video monitoring system according to the embodiments of the present invention.

### DESCRIPTION OF EMBODIMENTS

Embodiments of the present invention are described below with reference to the drawings.

### First Embodiment

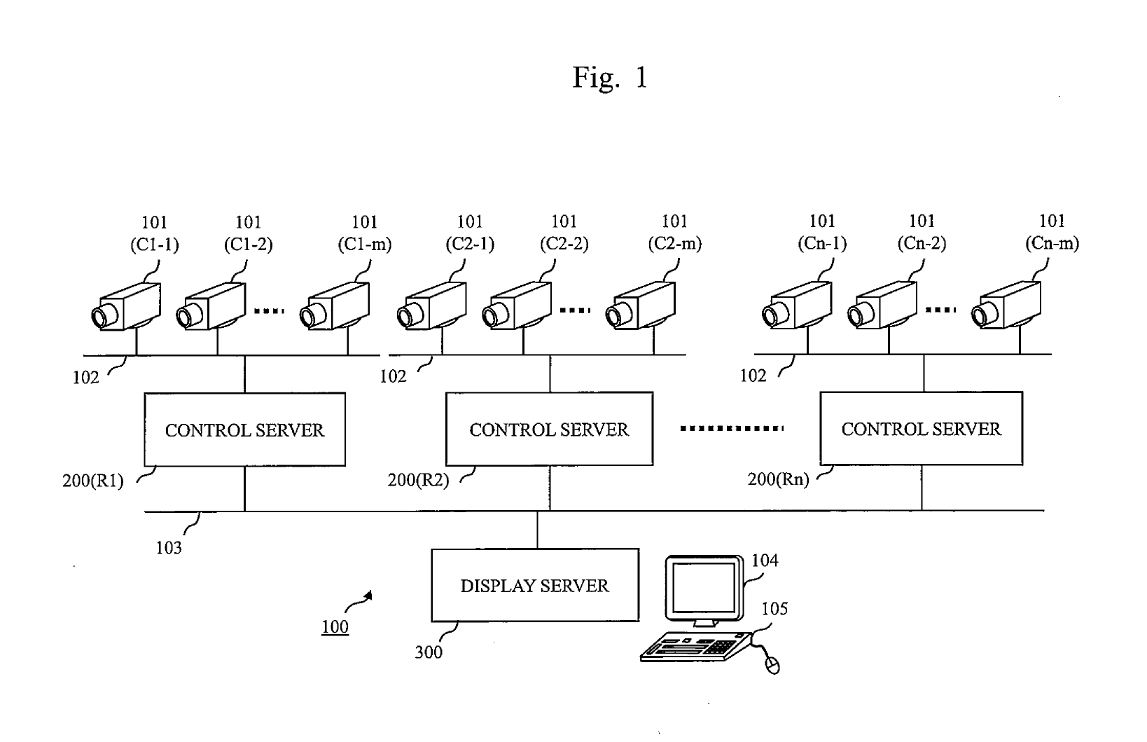

FIG. 1 is a block diagram of a structure of a video monitoring system 100 according to the present embodiment.

In FIG. 1, the video monitoring system 100 includes a plurality of monitor cameras 101 (monitor cameras C1-1, C1-2, . . . , C1-m, C2-1, C2-2, . . . , C2-m, . . . , Cn-1, Cn-2, . . . , and Cn-m), a plurality of control servers 200 (control servers R1, R2, . . . , and Rn), and a display server 300.

The monitor cameras C1-1, C1-2, . . . , and C1-m are connected to the control server R1 via a local area network 102 (LAN). Similarly, the monitor cameras C2-1, C2-2, . . . , C2-m, . . . , Cn-1, Cn-2, . . . , and Cn-m are connected to the control servers R2, . . . , and Rn via other LANs 102. The LANs 102 are used to transmit monitoring video from each monitor camera 101 and to transmit control information to each monitor camera 101. For example, the LANs 102 are the Ethernet (registered trademark). The LANs 102 are not limited to wired LANs. When the monitor cameras 101 each having a wireless LAN function are used, the LANs 102 may be wireless LANs. The LANs 102 may each be replaced to another kind of network such as a wide area network (WAN).

The control servers R1, R2, . . . , and Rn are connected to the common display server 300 via a LAN 103. The LAN 103 is used to transmit monitoring video from each control server 200 and transmit control information to each control server 200. For example, the LAN 103 is the Ethernet (registered trademark). The LAN 103 is not limited to a wired LAN and may be a wireless LAN. The LAN 103 may be replaced to another kind of network such as a WAN.

In the structure illustrated in FIG. 1, m monitor cameras 101 and a single control server 200 are connected to a single LAN 102. However, the numbers of monitor cameras 101 and control servers 200 connected to the single LAN 102 may be optionally selected. For example, the number of monitor cameras 101 connected to a LAN 102 may be different from that of monitor cameras 101 connected to another LAN 102. Two or more control servers 200 may be connected to the single LAN 102.

Further, in the structure illustrated in FIG. 1, n control servers 200 and a single display server 300 are connected to the LAN 103. However, the numbers of control servers 200 and display servers 300 connected to the LAN 103 may be optionally selected. For example, a single control server 200 may be connected to the LAN 103. Two or more display servers 300 may be connected to the LAN 103.

Each monitor camera 101 images video of the indoor or outdoor to be monitored. Each monitor camera 101 outputs the imaged video to any one of the control servers 200.

Each control server 200 receives an input of the video imaged by the plurality of monitor cameras 101. Each control server 200 records the video to a recording medium built therein. Each control server 200 converts the video received from the plurality of monitor cameras 101 or the video recorded to the recording medium into overhead view video. Each control server 200 synthesizes the overhead view video of the monitor cameras 101 adjacent to each other. After that, each control server 200 outputs the video imaged by the plurality of monitor cameras 101, the overhead view video which is obtained by converting that video, and the synthesized video to the display server 300.

Each control server 200 receives the input of the control information for the monitor camera 101 from the display server 300. Each control server 200 outputs the control information to each monitor camera 101.

The display server 300 receives the input of the video from the plurality of control servers 200. The display server 300 displays the video received from the plurality of control servers 200 on a display 104. The display server 300 receives an instruction from a monitoring person who is a user of the video monitoring system 100. For example, the display server 300 receives an operation for enlarging or reducing the display of the overhead view video by a keyboard and a mouse 105.

The display server 300 outputs the control information indicating the monitor camera 101 to output the video and the resolution and the frame rate of the video to be output to each control server 200 based on the instruction of the monitoring person.

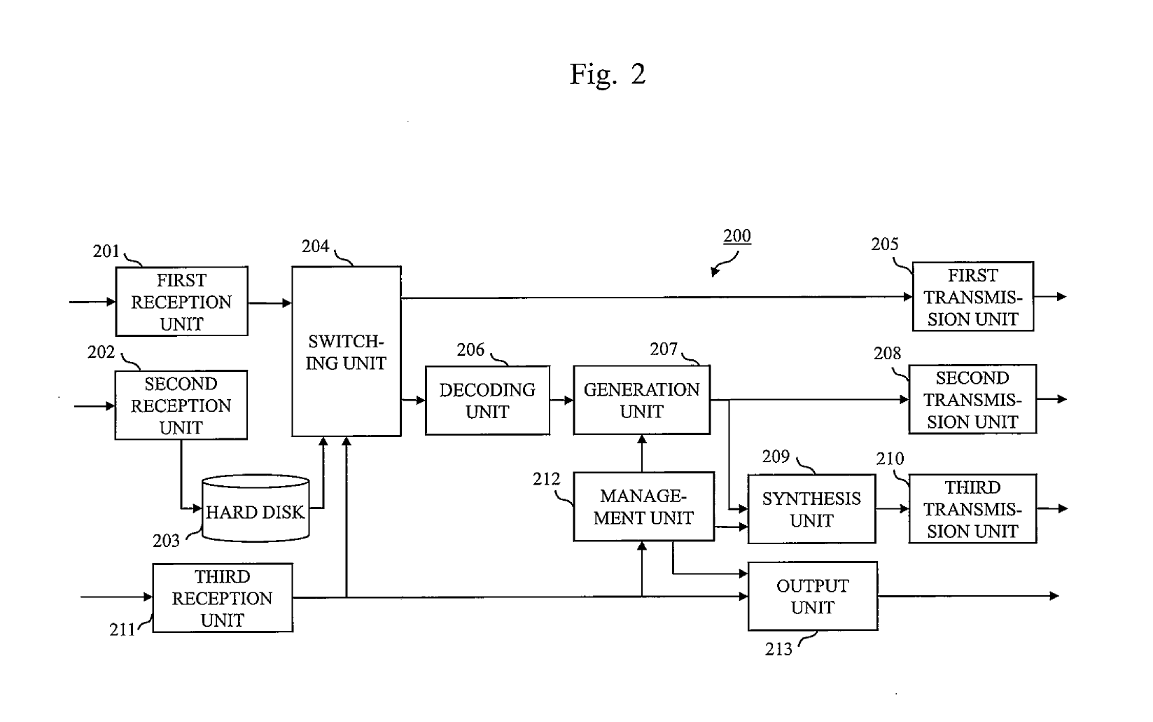

FIG. 2 is a block diagram of a structure of each control server 200.

In FIG. 2, each control server 200 includes a first reception unit 201, a second reception unit 202, a hard disk 203, a switching unit 204, a first transmission unit 205, a decoding unit 206, a generation unit 207, a second transmission unit 208, a synthesis unit 209, a third transmission unit 210, a third reception unit 211, a management unit 212, and an output unit 213.

Functions of units of the control server R1 are described below with reference to FIGS. 1 and 2.

The first reception unit 201 and the second reception unit 202 receive inputs of video of the monitor cameras C1-1, . . . , and C1-m via a LAN 102. The first reception unit 201 transmits video of the monitor cameras C1-1, . . . , and C1-m to be displayed as live video to the switching unit 204. The second reception unit 202 records video of the monitor cameras C1-1, . . . , and C1-m to be recorded to the hard disk 203. The hard disk 203 is an exemplary recording medium described above and may be replaced with another kind of recording medium such as a flash memory.

The switching unit 204 switches between the live video and the recorded video to be displayed on the display 104 based on the control by the third reception unit 211. When the live video is displayed on the display 104, the switching unit 204 obtains the video of the first reception unit 201. When the recorded video is displayed on the display 104, the switching unit 204 obtains the video of the hard disk 203 based on specified information such as time. The switching unit 204 outputs the obtained video to the first transmission unit 205. The switching unit 204 also outputs the obtained video to the decoding unit 206.

The first transmission unit 205 outputs the video obtained from the first reception unit 201 or the hard disk 203 to the display server 300 via the LAN 103.

The decoding unit 206 converts video which is encoded for transmission and reception into a bitmap image. The decoding unit 206 outputs the bitmap image to the generation unit 207.

The generation unit 207 converts the bitmap image input from the decoding unit 206 based on the angle of view information on the monitor cameras C1-1, . . . , and C1-m recorded in the management unit 212 and generates the overhead view video for looking down the object in the bitmap image from right above. The generation unit 207 outputs the overhead view video to the second transmission unit 208 and the synthesis unit 209.

The second transmission unit 208 obtains the overhead view video of each monitor camera 101 generated by the generation unit 207. The second transmission unit 208 transmits the overhead view video to the display server 300 via the LAN 103.

The synthesis unit 209 obtains the overhead view video generated by the generation unit 207. The synthesis unit 209 synthesizes the overhead view video of the monitor cameras 101 adjacent to each other based on position information on the monitor cameras C1-1, . . . , and C1-m recorded in the management unit 212. The synthesis unit 209 outputs the synthesized overhead view video to the third transmission unit 210.

The third transmission unit 210 outputs the synthesized overhead view video input from the synthesis unit 209 to the display server 300 via the LAN 103.

The third reception unit 211 receives information input from the keyboard and the mouse 105 (which may instead be the display 104 if the display 104 is a touch panel) of the display server 300 via the LAN 103. Included in this information are, for example, the position information on the monitor cameras C1-1, . . . , and C1-m and the angle of view information on the monitor cameras C1-1, . . . , and C1-m. Alternatively, information for specifying the resolution and the frame rate of the video output from the monitor cameras C1-1, . . . , and C1-m is included. Alternatively, information indicating video of which one of the monitor cameras C1-1, . . . , and C1-m is displayed and information for specifying the resolution and the frame rate of the video output from that monitor camera 101 are included.

The management unit 212 receives the input of the information from the third reception unit 211. The management unit 212 records the input information.

The output unit 213 outputs the information for specifying the resolution and the frame rate of the video which has been recorded to the management unit 212 to the monitor cameras C1-1, . . . , and C1-m via the LAN 102. Alternatively, the output unit 213, based on the information indicating video of which monitor camera 101 is displayed which has been recorded to the management unit 212, outputs the information for specifying the resolution and the frame rate of the video output from that monitor camera 101 which has been recorded to the management unit 212 to that monitor camera 101 via the LAN 102.

Functions of respective units of the control servers 200 other than the control server R1 are the same as those of the control server R1 described above.

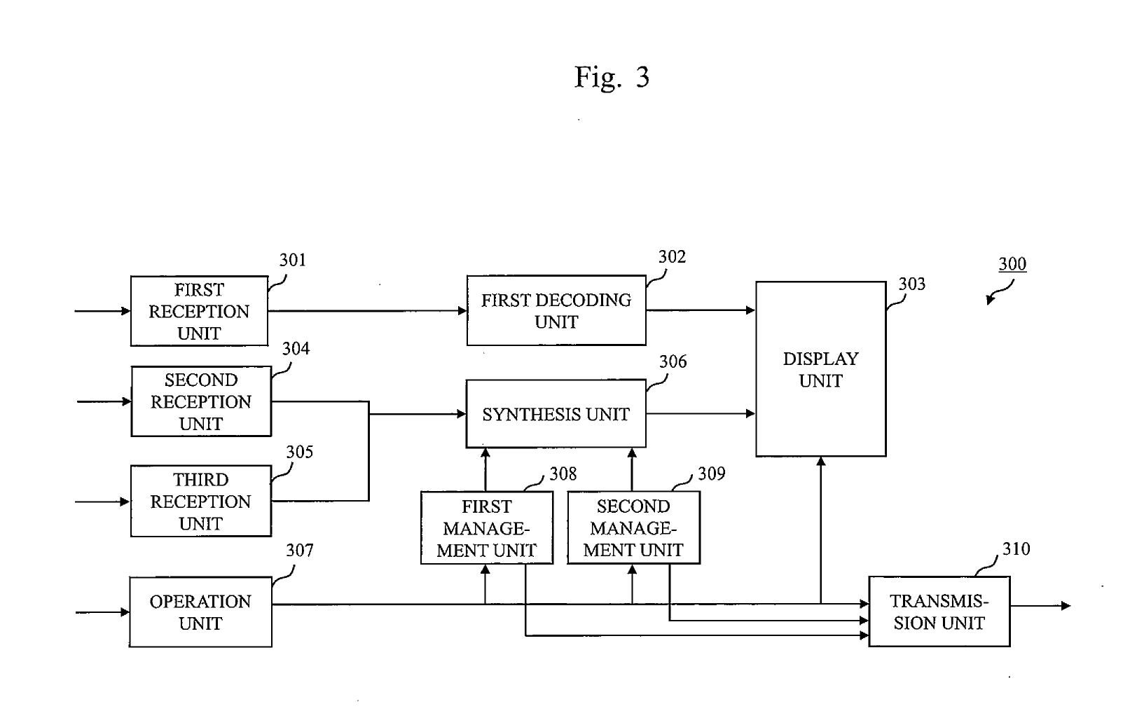

FIG. 3 is a block diagram of a structure of the display server 300.

In FIG. 3, the display server 300 includes a first reception unit 301, a first decoding unit 302, a display unit 303, a second reception unit 304, a third reception unit 305, a synthesis unit 306, an operation unit 307, a first management unit 308, a second management unit 309, and a transmission unit 310.

Functions of units of the display server 300 related to the control servers R1 and R2 are described below with reference to FIGS. 1 and 3.

The first reception unit 301 receives video output from the first transmission units 205 of the control servers R1 and R2 via the LAN 103. The first reception unit 301 outputs the received video to the first decoding unit 302.

The first decoding unit 302 decodes the video input from the first reception unit 301. The first decoding unit 302 outputs the decoded video to the display unit 303.

The display unit 303 displays the video input from the first decoding unit 302 on the display 104.

The second reception unit 304 receives overhead view video of each monitor camera 101 output from the second transmission units 208 of the control servers R1 and R2 via the LAN 103. The second reception unit 304 outputs the received overhead view video to the synthesis unit 306.

The third reception unit 305 receives the synthesized overhead view video output from the third transmission units 210 of the control servers R1 and R2 via the LAN 103. The third reception unit 305 outputs the received overhead view video to the synthesis unit 306.

The synthesis unit 306 synthesizes the overhead view video of each monitor camera 101 input from the second reception unit 304 and the synthesized overhead view video input from the third reception unit 305 and creates overhead view video of a whole. The synthesis unit 306 outputs the created overhead view video of the whole to the display unit 303.

The operation unit 307 receives information input from the keyboard and the mouse 105 (which may instead be the display 104 if the display 104 is a touch panel). Included in this information are, for example, the position information on the monitor cameras C1-1, C1-m, C2-1, . . . , and C2-m, the angle of view information on the monitor cameras C1-1, C1-m, C2-1, . . . , and C2-m, and map information on a whole place where the monitor cameras C1-1, C1-m, C2-1, . . . , and C2-m are placed. Alternatively, information regarding an operation for enlarging or reducing the display of the video is included. The information regarding the operation includes the information for specifying the resolution and the frame rate of the video to be output from each of the monitor cameras C1-1, C1-m, C2-1, . . . , and C2-m. Alternatively, information indicating video of which one of the monitor cameras C1-1, C1-m, C2-1, . . . , and C2-m is displayed and the information for specifying the resolution and the frame rate of the video output from that monitor camera 101 are included. The operation unit 307 outputs the input information to the first management unit 308, the second management unit 309, and the transmission unit 310.

The first management unit 308 receives inputs of the position information on the monitor cameras C1-1, C1-m, C2-1, . . . , and C2-m and the angle of view information on the monitor cameras C1-1, C1-m, C2-1, . . . , and C2-m. Further, the first management unit 308 receives the input of the information regarding the operation for enlarging or reducing the display of the video. The first management unit 308 outputs the input information to the synthesis unit 306.

The second management unit 309 receives the input of the map information. The second management unit 309 outputs the input map information to the synthesis unit 306.

The transmission unit 310 outputs the information input from the first management unit 308 and the second management unit 309 to the third reception units 211 of the control servers 200 via the LAN 103.

Functions of respective units of the display server 300 related to the control servers 200 other than the control servers R1 and R2 are the same as those related to the control servers R1 and R2 described above.

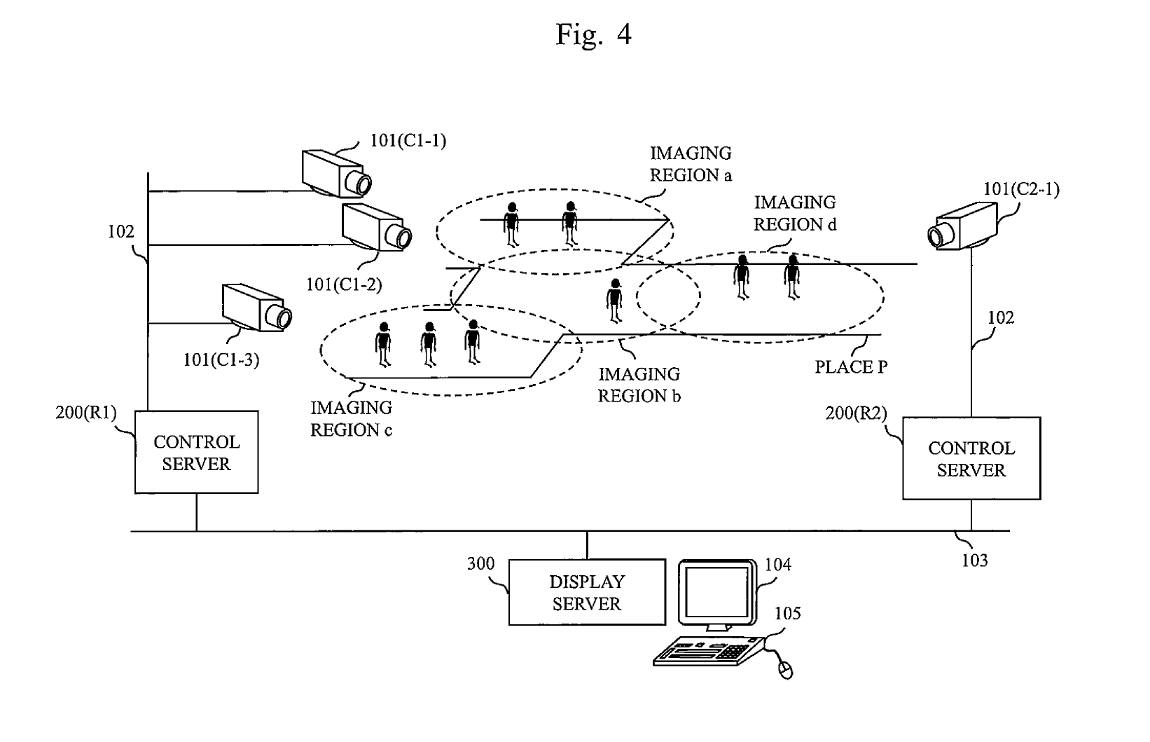

FIG. 4 is a diagram of an application of the video monitoring system 100.

In FIG. 4, for example, a place P is an inside of a large store, an amusement park, a platform of or a passage in a station, and a room or passage of an apartment or a building. The place P is normally imaged by a large number of monitor cameras 101. However, for simple description, it is assumed here that almost the whole place P be imaged by four monitor cameras C1-1, C1-2, C1-3, and C2-1.

The monitor camera C1-1 images an imaging region a of the place P. The monitor camera C1-2 images an imaging region b of the place P. The monitor camera C1-3 images an imaging region c of the place P. The monitor camera C2-1 images an imaging region d of the place P. The imaging regions a to d may be overlapped with each other.

The control server R1 receives monitoring video of the monitor cameras C1-1, C1-2, and C1-3 via a LAN 102. The control server R2 receives monitoring video of the monitor camera C2-1 via a LAN 102.

The display server 300 receives normal video of the monitor cameras C1-1, C1-2, C1-3, and C2-1 from the control servers R1 and R2, individual overhead view video of each of imaging regions a to d which is obtained by converting the normal video, and overhead view video of the whole place P which is obtained by synthesizing the individual overhead view video. The display server 300 displays the normal video and the overhead view video of the whole place P on the display 104. The display server 300 receives an operation for enlarging or reducing the displayed video or specifying the displayed area from the keyboard and the mouse 105. The display server 300 receives the inputs of map information on the place P, the position information on the monitor cameras C1-1, C1-2, C1-3, and C2-1, the angle of view information on the monitor cameras C1-1, C1-2, C1-3, and C2-1, and the information on the resolution and the frame rate of each of the monitor cameras C1-1, C1-2, C1-3, and C2-1 from the keyboard and the mouse 105. The display server 300 manages the input information.

A screen display of the display server 300 in the example in FIG. 4 is described below.

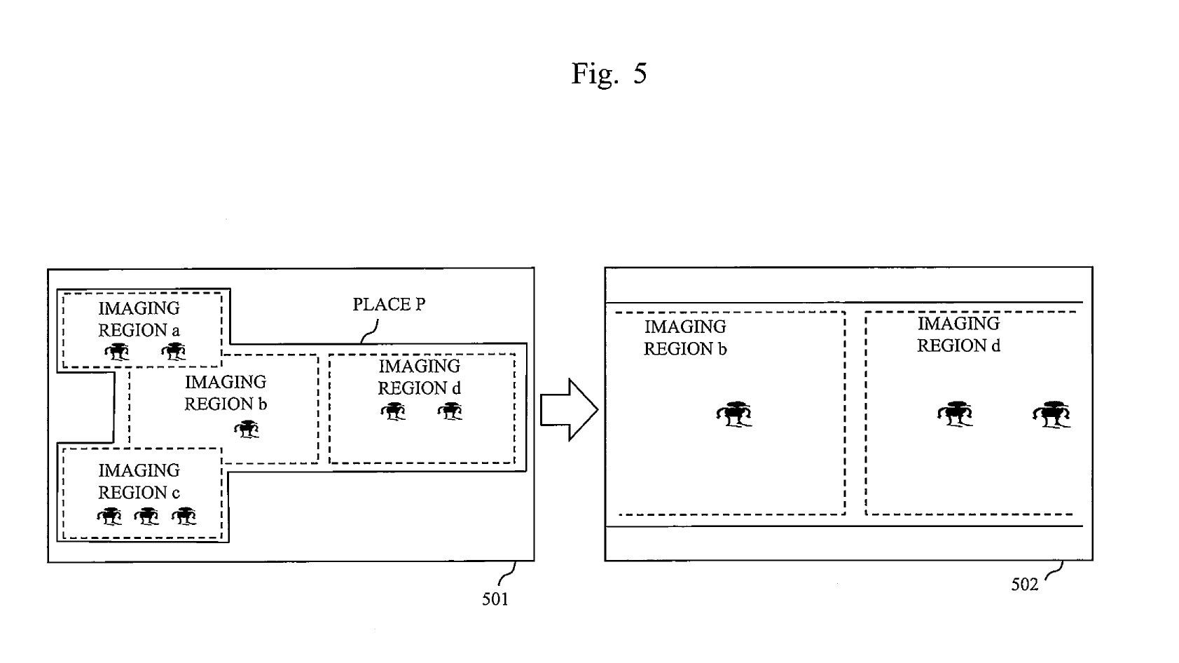

FIG. 5 is a diagram of an exemplary screen display of the display server 300.

In FIG. 5, a display screen 501 on the left side is overhead view video of the whole place P displayed on the display 104. When the monitoring person who constantly monitors the monitoring video for security or the like issues an instruction to display the video of the whole by using the keyboard and the mouse 105 of the display server 300, the video of the whole of the place P is displayed on the screen.

A display screen 502 on the right side is overhead view video of (part of) the imaging regions b and d displayed on the display 104. When the monitoring person issues an instruction to enlarge the display of the center portion of the display screen 501 (that is, enlarging instruction) by using the keyboard and the mouse 105 of the display server 300, the imaging regions a and c disappear from a display range of the screen, and enlarged video of the imaging regions b and d is displayed on the screen.

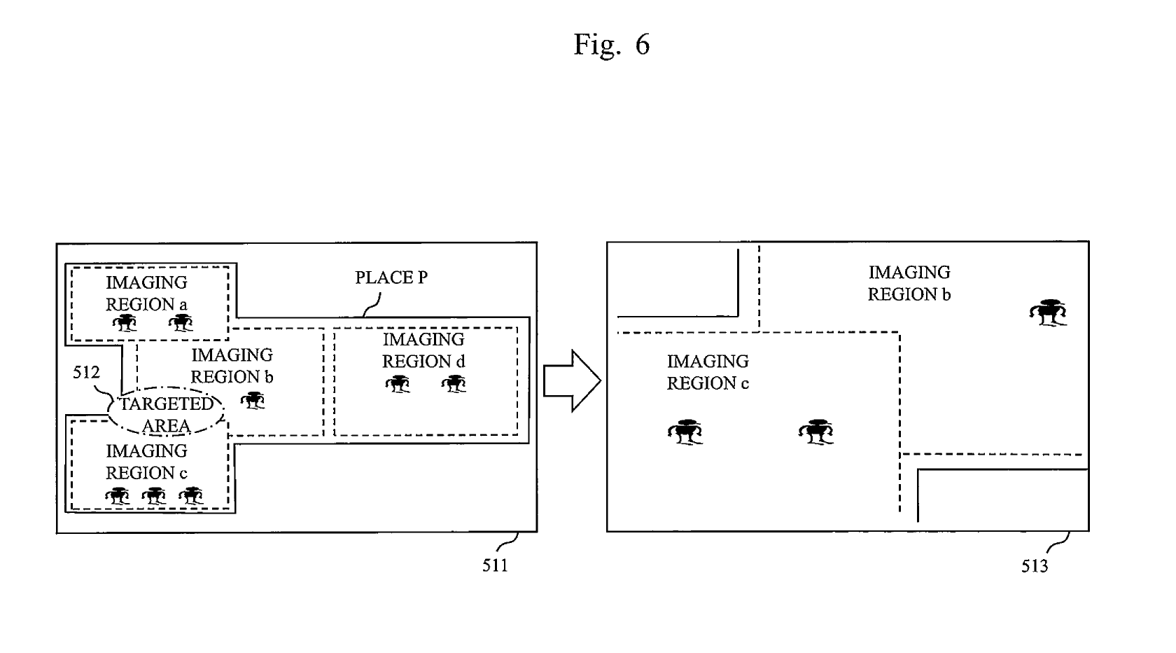

FIG. 6 is a diagram of another exemplary screen display of the display server 300.

In FIG. 6, a display screen 511 on the left side is, similarly to the display screen 501 on the left side in FIG. 5, overhead view video of the whole place P displayed on the display 104. The place P includes a targeted area 512. The targeted area 512 is a region that needs to be monitored in detail as a part of a monitoring operation by the monitoring person who constantly monitors the monitoring video for security or the like.

A display screen 513 on the right side is overhead view video of the targeted area 512 displayed on the display 104. When the monitoring person issues an instruction to enlarge the display of the targeted area 512 of the display screen 501 (that is, a targeting instruction) by using the keyboard and the mouse 105 of the display server 300, the imaging regions a and d disappear from the display range of the screen, and enlarged video of the imaging regions b and c is displayed on the screen.

An operation of the video monitoring system 100 in the example in FIG. 4 (video monitoring method according to the present embodiment) is described below.

First, a camera control operation is described.

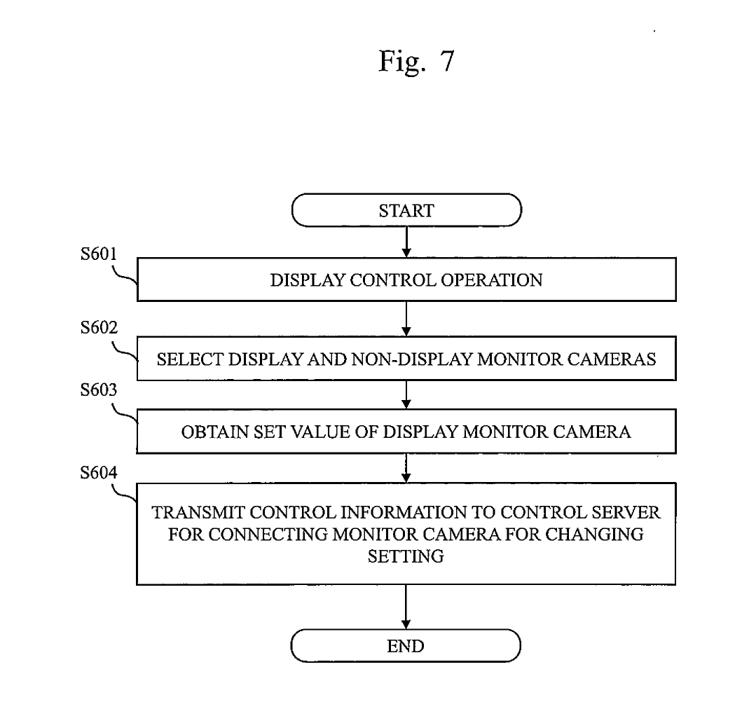

FIG. 7 is a flowchart of an exemplary operation of the display server 300 in a case where the monitoring person has issued the enlarging instruction or the targeting instruction of the displayed video.

In S601, the operation unit 307 receives an operation of the enlarging instruction or the targeting instruction as a display control operation from the monitoring person via the keyboard and the mouse 105. The operation unit 307 outputs the information on the imaging region to be displayed by the display control operation to the transmission unit 310.

In S602, the transmission unit 310 obtains the information on the monitor cameras C1-1, C1-2, C1-3, and C2-1 respectively imaging the imaging regions a to d from the first management unit 308 and the second management unit 309. The transmission unit 310 selects the display monitor camera or the non-display monitor camera based on the information input in S601 and the information obtained from the first management unit 308 and the second management unit 309. In the example of the enlarging instruction in FIG. 5, the monitor cameras C1-1 and C1-3 for imaging the imaging regions a and c are non-display monitor cameras, and the monitor cameras C1-2 and C2-1 for imaging the imaging regions b and d are display monitor cameras.

In S603, the transmission unit 310 obtains a set value of the display monitor camera selected in S602 from the first management unit 308. In the example of the enlarging instruction in FIG. 5, in order to enlarge the video of the monitor cameras C1-2 and C2-1, the resolution and the frame rate of each of the monitor cameras C1-2 and C2-1 are set to be high.

In S604, the transmission unit 310 obtains information on the control server 200 from the first management unit 308. The transmission unit 310 selects the control server 200 which has connected the monitor camera 101 of which the setting is need to be changed based on the obtained information. The transmission unit 310 outputs the control information to the third reception unit 211 of the selected control server 200. The control information includes information indicating the display and non-display monitor cameras selected in S602 and the set value obtained in S603. In the example of the enlarging instruction in FIG. 5, the control information, which indicates that the monitor cameras C1-1 and C1-3 are the non-display monitor cameras and the monitor camera C1-2 is the display monitor camera and specifies the resolution and the frame rate of the monitor camera C1-2, is transmitted to the control server R1. Further, the control information which indicates that the monitor camera C2-1 is the display monitor camera and specifies the resolution and the frame rate of the monitor camera C2-1 is transmitted to the control server R2.

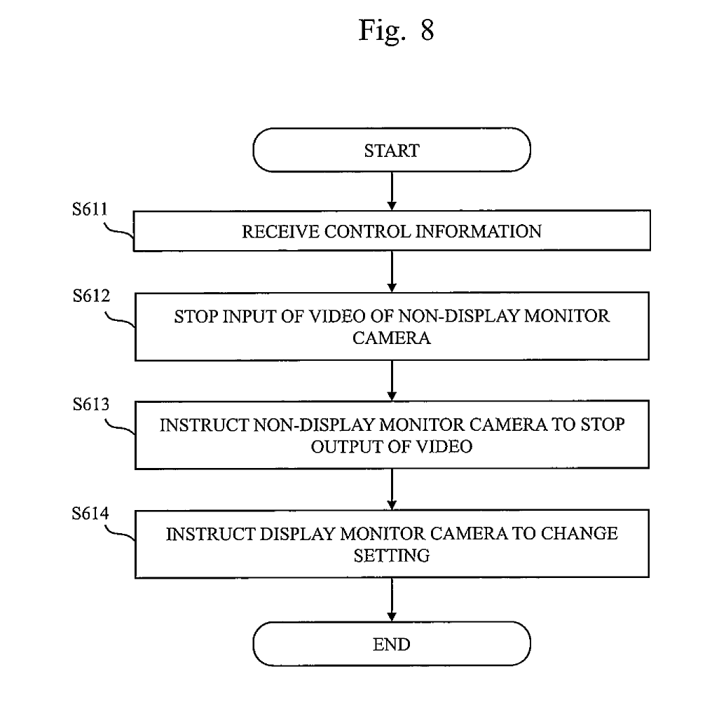

FIG. 8 is a flowchart of an exemplary operation of the control server R1 in a case where the control information is transmitted from the display server 300.

In S611, the third reception unit 211 receives the control information transmitted from the transmission unit 310 of the display server 300 in S604. The third reception unit 211 outputs the received control information to the switching unit 204 and the output unit 213.

In S612, the switching unit 204 performs processing to the video of the display monitor camera based on the control information input in S611. In the example of the enlarging instruction in FIG. 5, the inputs of the video of the monitor cameras C1-1 and C1-3 for imaging the imaging regions a and c are stopped, and the input of the video of the monitor camera C1-2 for imaging the imaging region b is received.

In S613, the output unit 213 instructs the non-display monitor camera to stop the output of the video based on the control information input in S611. In the example of the enlarging instruction in FIG. 5, an instruction to stop the output of the video is issued to each of the monitor cameras C1-1 and C1-3.

In S614, the output unit 213 instructs the display monitor camera to set the values of the resolution and the frame rate of the video to be output to be high based on the control information input in S611. In the example of the enlarging instruction in FIG. 5, the set values of the resolution and the frame rate are informed to the monitor camera C1-2.

An operation of the control server R2 when the control information is transmitted from the display server 300 is similar to that illustrated in FIG. 8.

Next, an operation for generating the overhead view video is described.

As described in S611 above, the third reception unit 211 receives the control information from the transmission unit 310 of the display server 300. The control information includes information specified by the operation of the monitoring person and information which has been previously set. For example, the control information includes information indicating which one of live video and recorded video is displayed on the screen of the display 104. Information indicating whether the overhead view video of the whole place P is displayed, whether the overhead view video of a partial imaging region is enlarged and displayed, and whether normal video of the partial imaging region (that is, monitoring video before being converted to the overhead view video) is displayed is included. As described above, there is a case where the information indicating the display and non-display monitor camera and the set value of the display monitor camera are included.

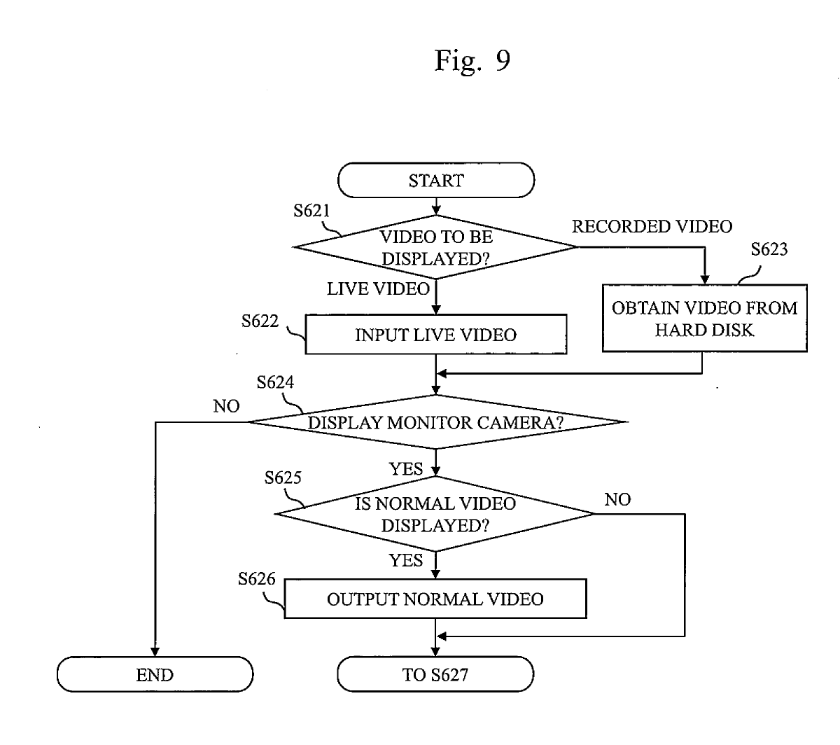

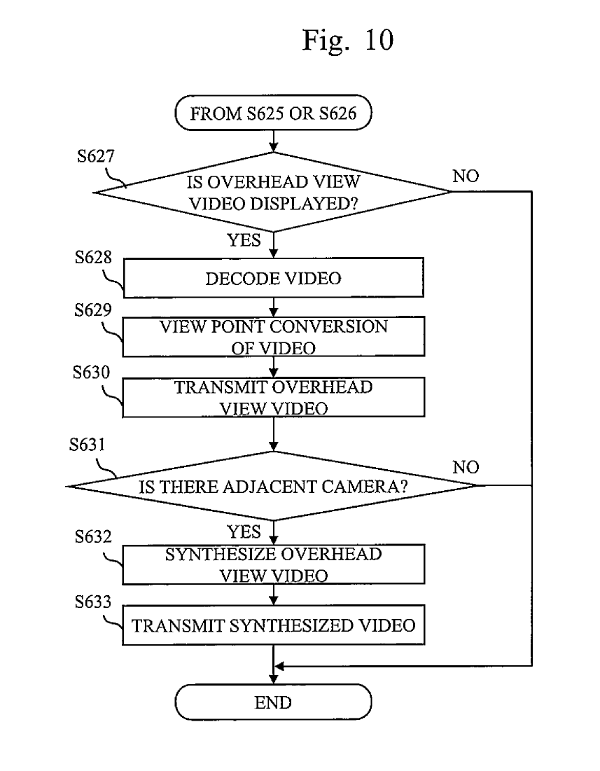

FIGS. 9 and 10 are flowcharts of an exemplary operation of the control server R1 when the video is transmitted from the display monitor camera.

In S621, the switching unit 204 switches the live video and the recorded video to be used based on the control information received by the third reception unit 211. When the video to be displayed is the live video, the flow proceeds to S622. When the video to be displayed is the recorded video, the flow proceeds to S623.

In S622, the switching unit 204 receives the input of the video from the first reception unit 201. After that, the flow proceeds to S624.

In S623, the switching unit 204 obtains the video from the hard disk 203. After that, the flow proceeds to S624.

In S624, the switching unit 204 determines whether the video is the video of the display monitor camera based on the control information received by the third reception unit 211. When the video is the video of the display monitor camera, the flow proceeds to S625. When the video is not the video of the display monitor camera, the flow ends. In the example of the enlarging instruction in FIG. 5, the monitor cameras C1-1 and C1-3 are the non-display monitor cameras, and the monitor camera C1-2 is a display camera. Therefore, when the video is the video of the monitor camera C1-2, the flow proceeds to S625. When the video is the video of each of the monitor cameras C1-1 and C1-3, the flow ends.

In S625, the switching unit 204 determines whether the video to be displayed is the normal video based on the control information received by the third reception unit 211. When the video to be displayed is the normal video, the flow proceeds to S626. When the video to be displayed is not the normal video, the flow proceeds to S627.

In S626, the switching unit 204 outputs the video obtained in S622 or S623 from the first transmission unit 205 to the first reception unit 301 of the display server 300.

In S627, the switching unit 204 determines whether the video to be displayed is the overhead view video based on the control information received by the third reception unit 211. When the video to be displayed is the overhead view video, the switching unit 204 outputs the video obtained in S622 or S623 to the decoding unit 206. After that, the flow proceeds to S628. When the video to be displayed is not the overhead view video, the flow ends.

In S628, the decoding unit 206 converts the video obtained in S622 or S623 into bitmap data. The decoding unit 206 outputs the bitmap data to the generation unit 207.

In S629, the generation unit 207 obtains the angle of view information on the monitor cameras C1-1, C1-2, and C1-3 from the management unit 212. The generation unit 207 creates the overhead view video from the bitmap data input in S628 based on the obtained angle of view information. The generation unit 207 outputs the created overhead view video to the second transmission unit 208 and the synthesis unit 209.

In S630, the second transmission unit 208 outputs the overhead view video input in S629 to the second reception unit 304 of the display server 300.

In S631, the synthesis unit 209 obtains the position information on the monitor cameras C1-1, C1-2, and C1-3 from the management unit 212. The synthesis unit 209 determines whether the monitor camera 101 adjacent to the monitor camera 101 corresponding to the overhead view video input in S629 exists based on the obtained position information. When the adjacent monitor camera 101 exists, the flow proceeds to S632. When the adjacent monitor camera 101 does not exist, the flow ends.

In S632, the synthesis unit 209 synthesizes the overhead view video input in S629 and the overhead view video of the adjacent monitor camera 101. When the display screen 501 on the left side of the example in FIG. 5 is created, the overhead view video of the monitor cameras C1-1, C1-2, and C1-3 are input in S629, and synthesis processing to the overhead view video is performed in S632. When the display screen 502 on the right side is created, the overhead view video of the monitor camera C1-2 is generated in S629, and the synthesis processing to the overhead view video is not performed.

In S633, the synthesis unit 209 outputs the overhead view video synthesized in S632 to the third transmission unit 210. The third transmission unit 210 outputs the input overhead view video to the third reception unit 305 of the display server 300.

The operation of the control server R2 when the video is transmitted from the display monitor camera is similar to those illustrated in FIGS. 9 and 10.

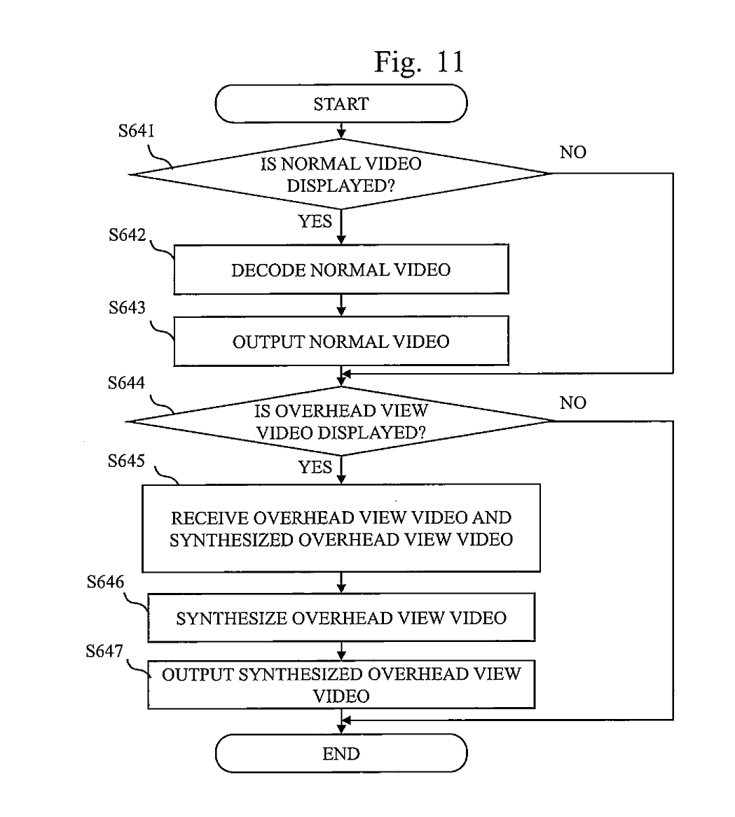

FIG. 11 is a flowchart of an exemplary operation of the display server 300 in a case where the video is transmitted from the control servers R1 and R2.

In S641, when the video to be displayed is the normal video, the first reception unit 301 receives the video from the first transmission unit 205 of the control server R1 or the control server R2. The first reception unit 301 outputs the received video to the first decoding unit 302. After that, the flow proceeds to S642. When the video to be displayed is not the normal video, the flow proceeds to S644.

In S642, the first decoding unit 302 decodes the video input in S641. The first decoding unit 302 outputs the decoded video to the display unit 303.

In S643, the display unit 303 displays the video input in S642 on the display 104.

In S644, when the video to be displayed is the overhead view video, the flow proceeds to S645. When the video to be displayed is not the overhead view video, the flow ends.

In S645, the second reception unit 304 receives the video from the second transmission unit 208 of at least one of the control server R1 and the control server R2. There is a case where the third reception unit 305 receives the video from the third transmission unit 210 of at least one of the control server R1 and the control server R2. The second reception unit 304 and the third reception unit 305 output the received video to the synthesis unit 306.

In S646, the synthesis unit 306 obtains the position information on the monitor cameras C1-1, C1-2, C1-3, and C2-1 from the first management unit 308. The synthesis unit 306 obtains the map information from the second management unit 309. The synthesis unit 306 synthesizes the video input in S645 based on the obtained position information and map information if necessary. The synthesis unit 306 outputs the synthesized video to the display unit 303. The synthesis unit 306 outputs the video input in S645 to the display unit 303 when the synthesis is not needed. When the display screen 501 on the left side of the example in FIG. 5 is created, the overhead view video obtained by synthesizing the overhead view video of the monitor cameras C1-1, C1-2, and C1-3 and the overhead view video of the monitor camera C2-1 are input in S645, and the synthesis processing to the overhead view video is performed in S646. When the display screen 502 on the right side is created, the overhead view video of the monitor camera C1-2 and the overhead view video of the monitor camera C2-1 are input in S645, and the synthesis processing to the overhead view video is performed in S646.

In S647, the display unit 303 displays the video input in S646 on the display 104.

As described above, in the present embodiment, when the overhead view video of the whole place P is displayed, the resolutions and the frame rates of the monitor cameras C1-1, C1-2, C1-3, and C2-1 are reduced. Therefore, the video can be transmitted to the display server 300 without compressing a network band. According to this, a system for providing video which looks down a whole place where it is necessary to place more than thousands of monitor cameras 101 such as a large shopping center, an amusement park, a platform of or a passage in a station can be constructed.

In the present embodiment, when the overhead view video is enlarged, a targeted point is displayed, and the normal video is displayed, the resolutions and the frame rates of the monitor cameras 101 for imaging the region to be displayed are set to be high while stopping the outputs of the video of the monitor cameras 101 for imaging the region which is not displayed. Therefore, a clearer image of the region where detailed monitoring is needed can be displayed on the display 104.

In the present embodiment, the video monitoring system 100 includes the first reception unit 201 and the second reception unit 202 in each control server 200 as a reception unit. The reception unit receives imaged video from a plurality of monitor cameras 101 (in the example in FIG. 5, the monitor cameras C1-1, C1-2, C1-3, and C2-1). Each monitor camera 101 images video of a corresponding region among a plurality of regions (in the example in FIG. 5, the imaging regions a to d) in a certain place P.

The video monitoring system 100 includes the synthesis unit 209 in each control server 200 and the display unit 303 and the synthesis unit 306 in the display server 300 as a control unit. The control unit performs control to display the video received by the reception unit on a screen (for example, the screen of the display 104).

The video monitoring system 100 includes the operation unit 307 in the display server 300. The operation unit 307 receives an operation (for example, the display control operation) for specifying a limited region (in the example of the enlarging instruction in FIG. 5, the imaging regions b and d) among the plurality of regions.

The video monitoring system 100 includes the management unit 212 and the output unit 213 in each control server 200 and the first management unit 308, the second management unit 309, and the transmission unit 310 in the display server 300 as an instruction unit. When video of the plurality of regions is displayed on the screen by the control unit, the instruction unit instructs the plurality of monitor cameras 101 to transmit the imaged video in a first format. When video of the region specified to the operation unit 307 is displayed on the screen by the control unit, the instruction unit instructs a monitor camera 101 (in the example of the enlarging instruction in FIG. 5, the monitor cameras C1-2 and C2-1) which images the video of the specified region to transmit the imaged video in a second format. The second format has a larger data amount than the first format. For example, the first and second formats are determined so that at least one of the resolution and the frame rate of the video transmitted in the first format is lower than that of the video transmitted in the second format.

According to the present embodiment, by performing the above operations, the communication band necessary for transmitting the video imaged by the plurality of monitor cameras 101 can be reduced without disrupting video monitoring operation.

When the video of the region specified to the operation unit 307 is displayed on the screen by the control unit, it is preferable that the instruction unit instruct the monitor camera 101 other than the monitor camera 101 which images the video of the specified region (in the example of the enlarging instruction in FIG. 5, the monitor cameras C1-1 and C1-3) among the plurality of monitor cameras 101 not to transmit the imaged video. In this way, a wider communication band can be used to transmit the video to be displayed.

In the present embodiment, the video monitoring system 100 further includes the generation unit 207 in each control server 200. The generation unit 207 converts the video received from each of the plurality of monitor cameras 101 by the reception unit and generates overhead view video corresponding to video looking down the above-mentioned corresponding region from right above (for example, the overhead view video of each of the imaging regions a to d).

When the video of the plurality of regions is displayed on the screen, the control unit creates overhead view video of the whole place P by synthesizing the overhead view video generated by the generation unit 207 and performs control to display the created overhead view video on the screen.

According to the present embodiment, an efficiency of the video monitoring operation is improved by performing the above operations.

In the present embodiment, the classification of the functions of the control servers 200 and the display server 300 is not limited to the one described above and can be appropriately changed. For example, the control servers 200 and the display server 300 may be integrated as a single server.

### Second Embodiment

Regarding the present embodiment, a difference from the first embodiment is mainly described.

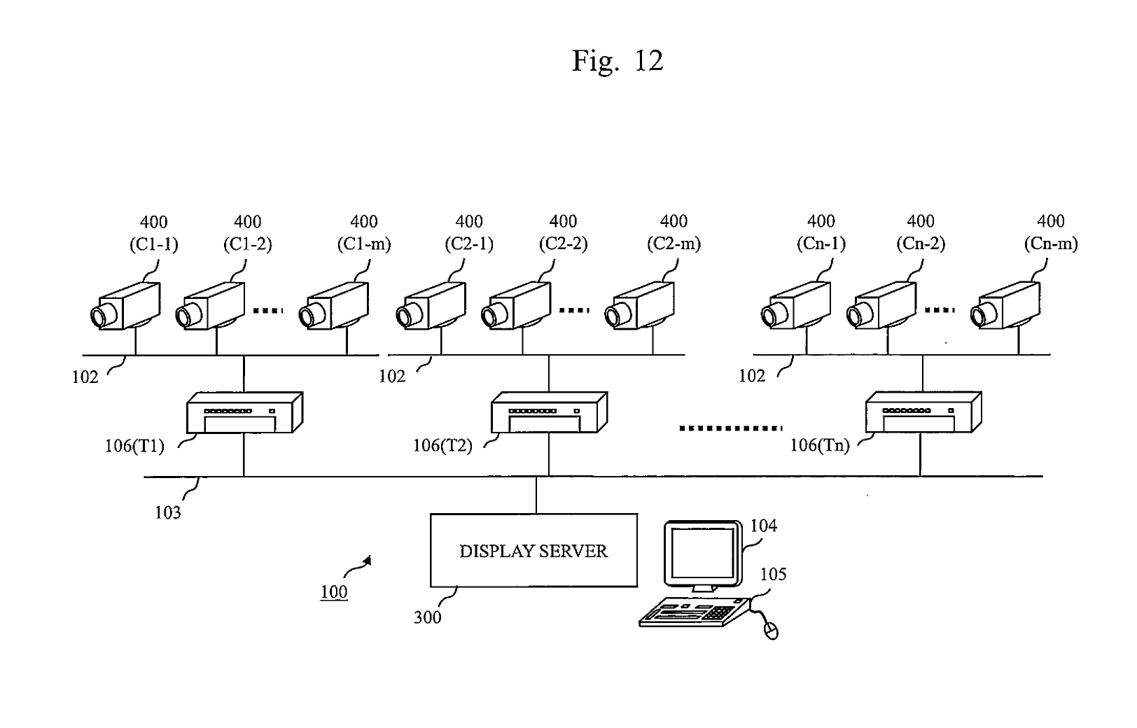

FIG. 12 is a block diagram of a structure of a video monitoring system 100 according to the present embodiment.

In FIG. 12, the video monitoring system 100 includes a plurality of monitor cameras 400 (monitor cameras C1-1, C1-2, . . . , C1-m, C2-1, C2-2, . . . , C2-m, . . . , Cn-1, Cn-2, . . . , and Cn-m), a plurality of network devices 106 (network devices T1, T2, . . . , and Tn), and a display server 300.

The monitor cameras C1-1, C1-2, . . . , and C1-m are connected to the network device T1 via a LAN 102. Similarly, the monitor cameras C2-1, C2-2, . . . , C2-m, . . . , Cn-1, Cn-2, . . . , and Cn-m are connected to the network devices T2, . . . , and Tn via other LANs 102. The LANs 102 are used to transmit monitoring video from each monitor camera 400 and to transmit control information to each monitor camera 400.

The network devices T1, T2, . . . , and Tn are connected to the common display server 300 via a LAN 103. The LAN 103 is used to transmit monitoring video from each network device 106 and to transmit control information to each network device 106.

The network devices T1, T2, . . . , and Tn divide the monitor cameras C1-1, C1-2, . . . , and C1-m into network segments. For example, the network devices T1, T2, . . . , and Tn are LAN switches.

In the first embodiment, as illustrated in FIG. 1, the video monitoring system 100 includes the plurality of control servers 200 which converts view points of the video imaged by the monitor cameras 101 (that is, generating overhead view video). Whereas, in the present embodiment, as illustrated in FIG. 12, each control server 200 is replaced with the network device 106, and the view points of the monitoring video are converted by the monitor cameras 400.

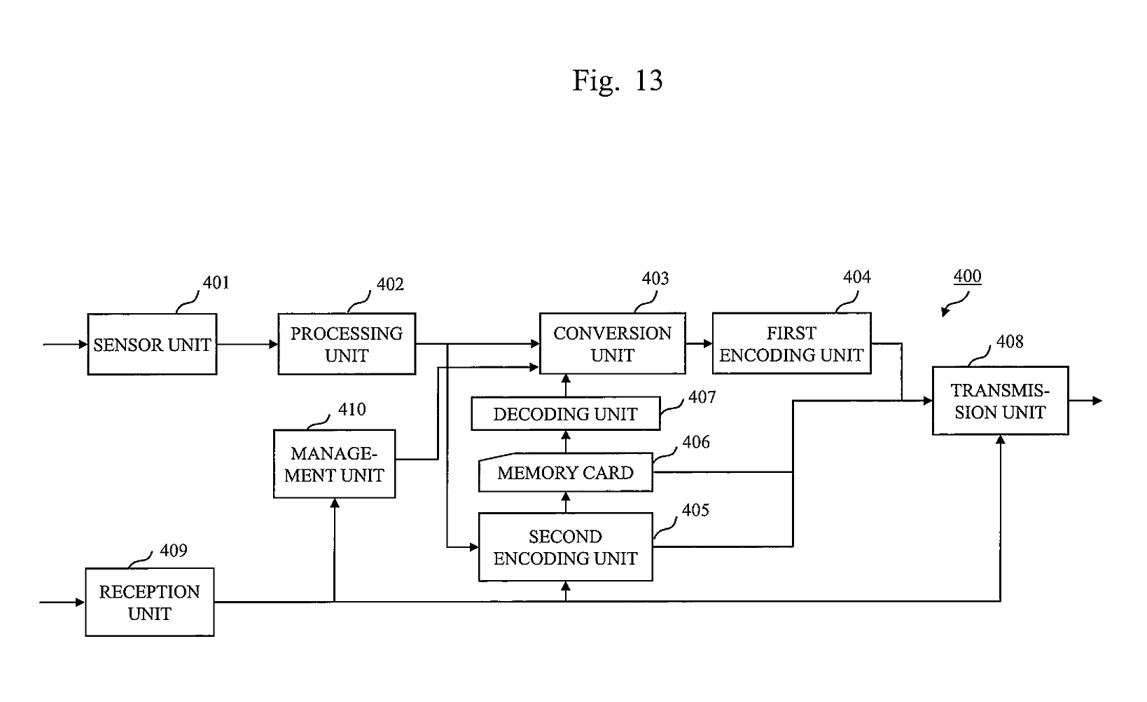

FIG. 13 is a block diagram of a structure of each monitor camera 400.

In FIG. 13, each monitor camera 400 includes a sensor unit 401, a processing unit 402, a conversion unit 403, a first encoding unit 404, a second encoding unit 405, a memory card 406, a decoding unit 407, a transmission unit 408, a reception unit 409, and a management unit 410. An operation of each unit is described below. It is preferable that the memory card 406 be removable.

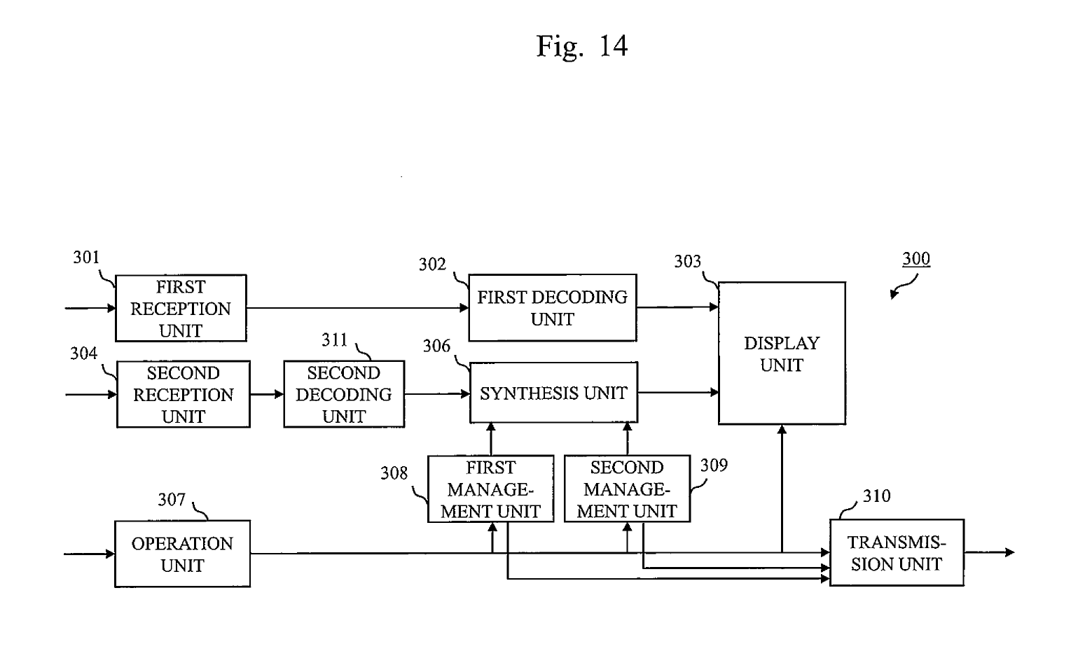

FIG. 14 is a block diagram of a structure of the display server 300.

In FIG. 14, the display server 300 includes a first reception unit 301, a first decoding unit 302, a display unit 303, a second reception unit 304, a synthesis unit 306, an operation unit 307, a first management unit 308, a second management unit 309, a transmission unit 310, and a second decoding unit 311. An operation of each unit is described below.

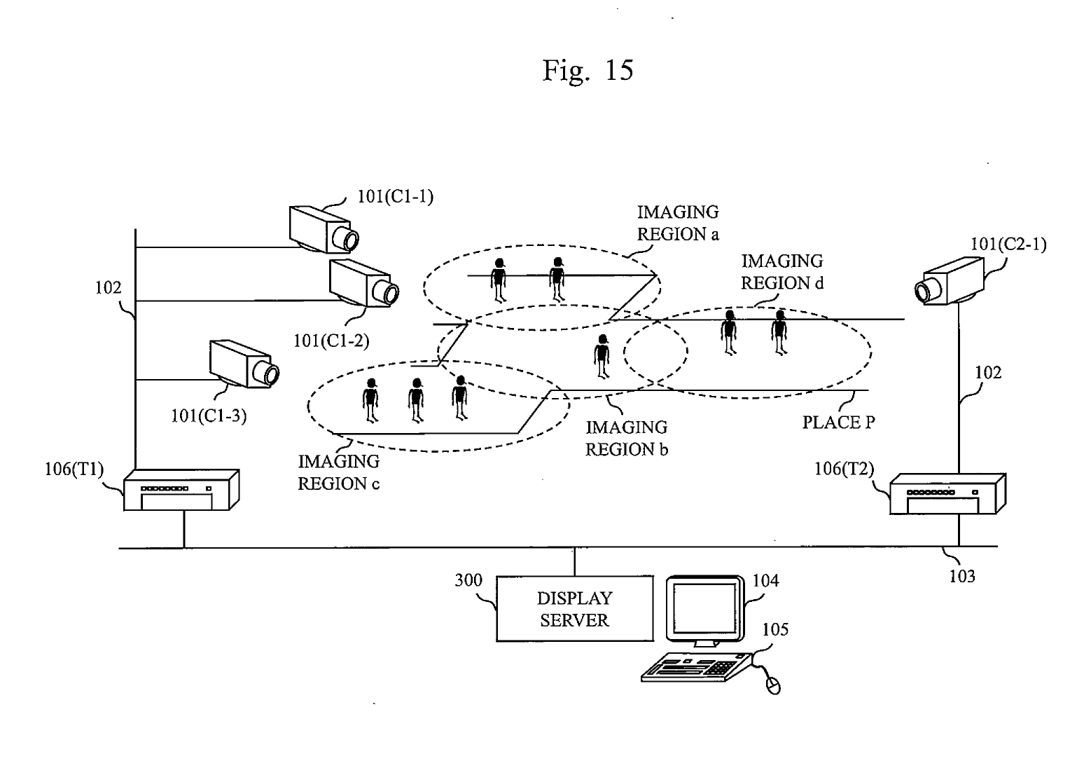

FIG. 15 is a diagram of an application of the video monitoring system 100.

In FIG. 15, a relation between the monitor cameras C1-1, C1-2, C1-3, and C2-1 and imaging regions a to d in a place P is the same as that in the example in FIG. 4. The video imaged by the monitor cameras C1-1, C1-2, and C1-3 is output to the display server 300 via the network device T1. The video imaged by the monitor camera C2-1 is output to the display server 300 via the network device T2.

In the example in FIG. 15, the screen similar to the display screens 501 and 502 illustrated in FIG. 5 and the display screens 511 and 513 illustrated in FIG. 6 is displayed on the display 104 by the display server 300.

An operation of the video monitoring system 100 in the example in FIG. 15 (video monitoring method according to the present embodiment) is described below.

First, a camera control operation is described.

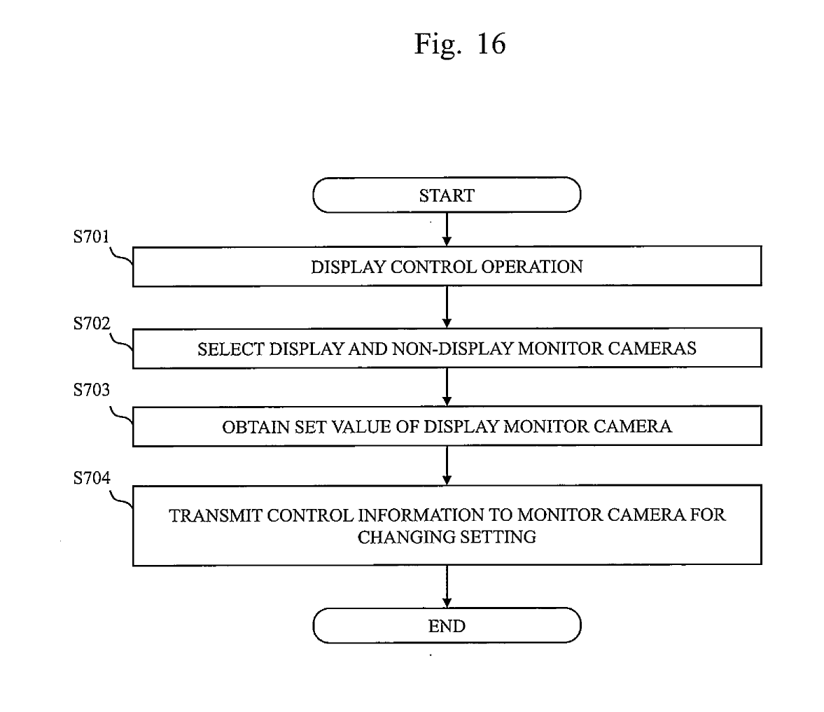

FIG. 16 is a flowchart of an exemplary operation of the display server 300 in a case where a monitoring person has issued an enlarging instruction or a targeting instruction of the displayed video.

In S701, the operation unit 307 receives an operation of the enlarging instruction or the targeting instruction as a display control operation from the monitoring person via the keyboard and the mouse 105. The operation unit 307 outputs information on the imaging region to be displayed by the display control operation to the transmission unit 310.

In S702, the transmission unit 310 obtains the information on the monitor cameras C1-1, C1-2, C1-3, and C2-1 respectively imaging the imaging regions a to d from the first management unit 308 and the second management unit 309. The transmission unit 310 selects the display monitor camera or the non-display monitor camera based on the information input in S701 and the information obtained from the first management unit 308 and the second management unit 309. In the example of the enlarging instruction in FIG. 5, the monitor cameras C1-1 and C1-3 for imaging the imaging regions a and c are non-display monitor cameras, and the monitor cameras C1-2 and C2-1 for imaging the imaging regions b and d are display monitor cameras.

In S703, the transmission unit 310 obtains a set value of the display monitor camera selected in S702 from the first management unit 308. In the example of the enlarging instruction in FIG. 5, in order to enlarge the video of the monitor cameras C1-2 and C2-1, the resolution and the frame rate of each of the monitor cameras C1-2 and C2-1 are set to be high.

In S704, the transmission unit 310 outputs the control information to the reception unit 409 of the monitor camera 400 of which setting change is needed. The control information includes information indicating that which one of the display and non-display monitor cameras is determined in S702 as the monitor camera 400 which is a transmission destination and the set value obtained in S703. In the example of the enlarging instruction in FIG. 5, the control information indicating that the monitor camera C1-1 is the non-display monitor camera is transmitted to the monitor camera C1-1. Further, similar control information is transmitted to the monitor camera C1-3. The control information which indicates that the monitor camera C1-2 is the display monitor camera and specifies the resolution and the frame rate of the monitor camera C1-2 is transmitted to the monitor camera C1-2. Similar control information is transmitted to the monitor camera C2-1.

Next, a camera setting operation is described.

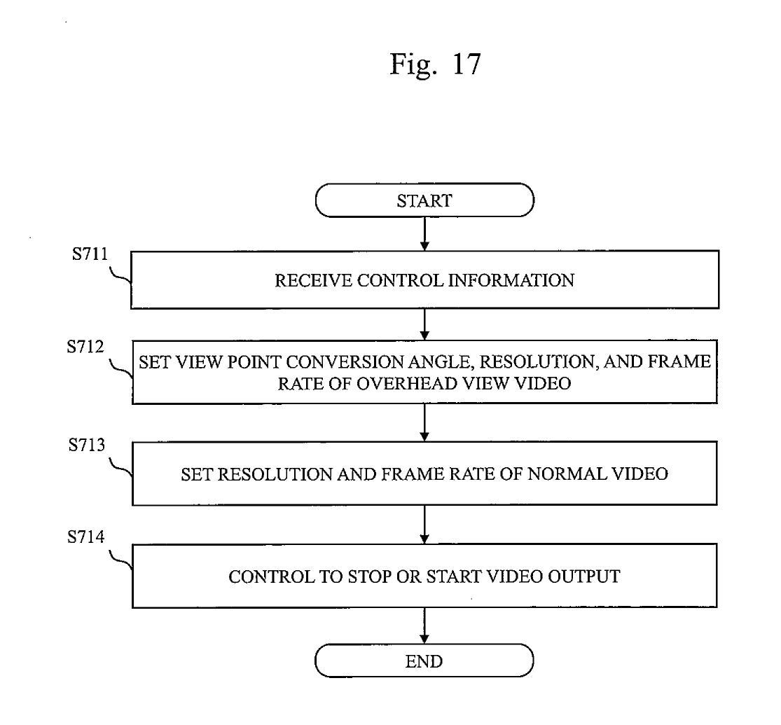

FIG. 17 is a flowchart of an exemplary operation of the monitor camera C1-2 in a case where the control information is transmitted from the display server 300.

In S711, the reception unit 409 receives the control information transmitted from the transmission unit 310 of the display server 300. The reception unit 409 outputs the received control information to the management unit 410. The control information includes information specified by the operation of the monitoring person and information which has been previously set. For example, the control information includes information indicating which one of live video and recorded video is displayed on the screen of the display 104. Information indicating whether the overhead view video of the whole place P is displayed, whether the overhead view video of a partial imaging region is enlarged and displayed, and whether normal video of the partial imaging region (that is, monitoring video before being converted to the overhead view video) is displayed is included. As the control information transmitted in S704, there is a case where the control information includes the information indicating which one of the display and non-display monitor cameras is the monitor camera 400 that is the transmission destination and the set value of the monitor camera 400 that is the transmission destination.

In S712, the management unit 410 sets the point of view conversion angle, the resolution, and the frame rate of the overhead view video relative to the conversion unit 403 based on the control information input in S711. In the example of the enlarging instruction in FIG. 5, the resolution and the frame rate of the overhead view video are set to be high.

In S713, the reception unit 409 sets the resolution and the frame rate of the normal video relative to the second encoding unit 405 based on the control information received in S711.

In S714, the reception unit 409 controls the transmission unit 408 so as to stop or start (or restart) the output of the video based on the control information received in S711. In the example of the enlarging instruction in FIG. 5, the output of the video starts.

The operation of each of the monitor cameras C1-1, C1-3, and C2-1 in a case where the control information is transmitted from the display server 300 is similar to that illustrated in FIG. 17. In the example of the enlarging instruction in FIG. 5, the outputs of the video from the monitor cameras C1-1 and C1-3 are stopped in S714, and the output of the video from the monitor camera C2-1 starts in S714.

Next, an operation for generating the overhead view video is described.

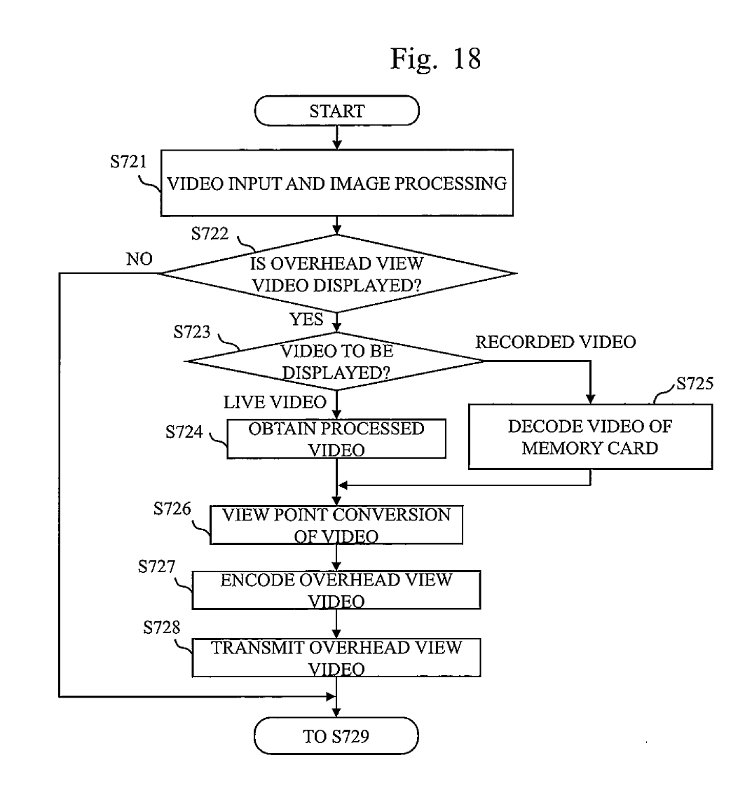

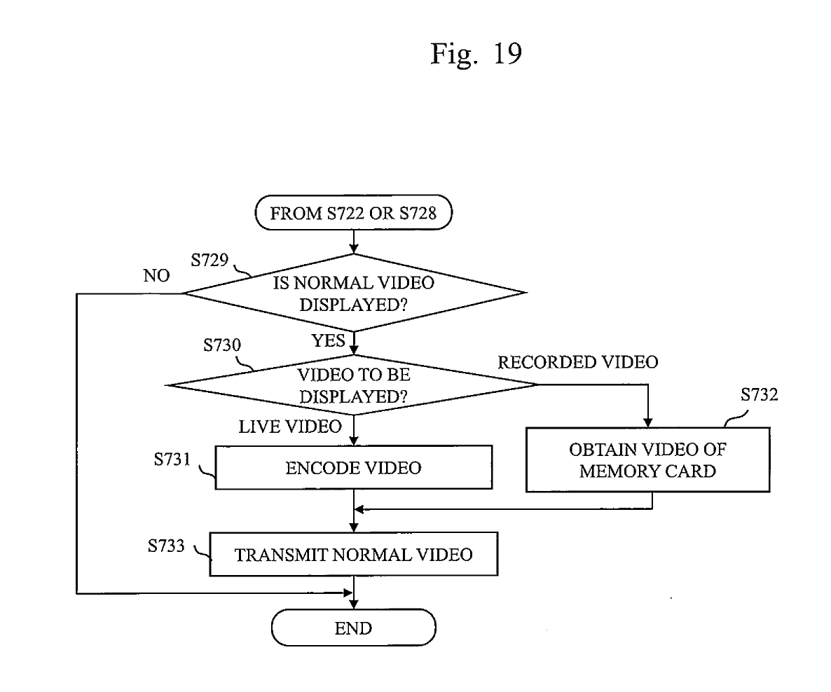

FIGS. 18 and 19 are flowcharts of an exemplary operation of the monitor camera C1-2 at the time of transmitting the video.

In S721, the sensor unit 401 images the video of the imaging region b by using an image sensor. The sensor unit 401 outputs the imaged video to the processing unit 402. The processing unit 402 performs image processing such as noise elimination to the video input from the sensor unit 401.

In S722, the reception unit 409 determines whether the video to be displayed is the overhead view video based on the control information received in S711. When the video to be displayed is the overhead view video, the flow proceeds to S723. When the video to be displayed is not the overhead view video, the flow proceeds to S730.

In S723, the reception unit 409 switches the live video and the recorded video to be used based on the control information received in S711. When the video to be displayed is the live video, the flow proceeds to S724. When the video to be displayed is the recorded video, the flow proceeds to S725.

In S724, the conversion unit 403 receives the input of the video processed in S721 from the processing unit 402. After that, the flow proceeds to S726.

In S725, the conversion unit 403 obtains the video which has been read from the memory card 406 and decoded by the decoding unit 407. After that, the flow proceeds to S726.

In S726, the conversion unit 403 obtains the angle of view information on the monitor camera C1-2 from the management unit 410. The conversion unit 403 converts the point of view of the video obtained in S724 or S725 based on the obtained angle of view information and creates the overhead view video. The conversion unit 403 outputs the created overhead view video to the first encoding unit 404.

In S727, the first encoding unit 404 encodes the overhead view video input in S726. The first encoding unit 404 outputs the encoded overhead view video to the transmission unit 408.

In S728, the transmission unit 408 outputs the overhead view video input in S727 to the second reception unit 304 of the display server 300. In the example in FIG. 5, the overhead view video of the imaging region b is transmitted.

In S729, the reception unit 409 determines whether the video to be displayed is the normal video based on the control information received in S711. When the video to be displayed is the normal video, the flow proceeds to S730. When the video to be displayed is not the normal video, the flow ends.

In S730, the reception unit 409 switches the live video and the recorded video to be used based on the control information received in S711. When the video to be displayed is the live video, the flow proceeds to S731. When the video to be displayed is the recorded video, the flow proceeds to S732.

In S731, the second encoding unit 405 receives the input of the video processed in S721 from the processing unit 402. The second encoding unit 405 encodes the input video. The second encoding unit 405 outputs the encoded video to the transmission unit 408. After that, the flow proceeds to S733.

In S732, the transmission unit 408 obtains the video from the memory card 406. After that, the flow proceeds to S733.

In S733, the transmission unit 408 outputs the video obtained in S731 or S732 to the first reception unit 301 of the display server 300.

The operation of each of the monitor cameras C1-1, C1-3, and C2-1 at the time of transmitting the video is similar to those illustrated in FIGS. 18 and 19. When the display screen 501 on the left side of the example in FIG. 5 is created, the overhead view video of the imaging regions a, c, and d from the respective monitor cameras C1-1, C1-3, and C2-1 is transmitted in S728. When the display screen 502 on the right side is created, the overhead view video of the imaging region d is transmitted from the monitor camera C2-1 in S728, and the overhead view video of the imaging regions a and c is not transmitted.

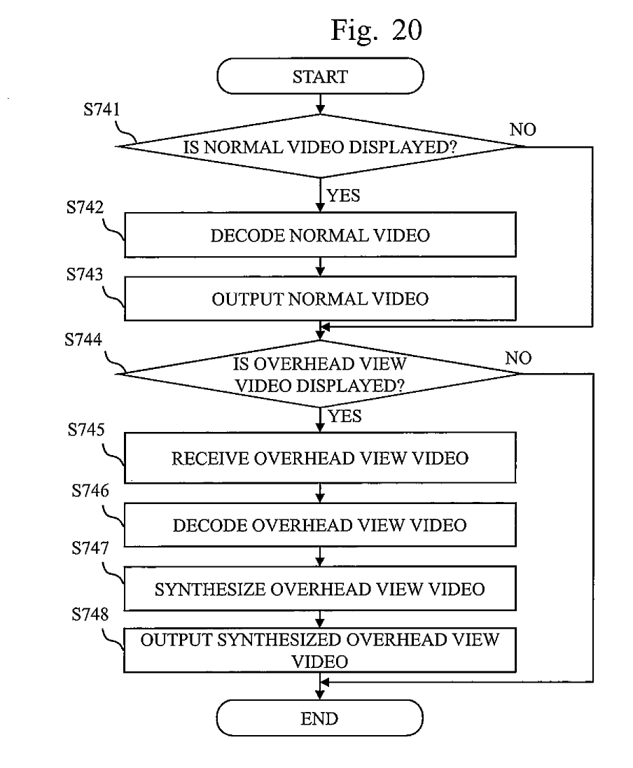

FIG. 20 is a flowchart of an exemplary operation of the display server 300 when the video is transmitted from the display monitor camera.

In S741, when the video to be displayed is the normal video, the first reception unit 301 receives the video from the transmission unit 408 of the display monitor camera. The first reception unit 301 outputs the received video to the first decoding unit 302. After that, the flow proceeds to S742. When the video to be displayed is not the normal video, the flow proceeds to S744.

In S742, the first decoding unit 302 decodes the video input in S741. The first decoding unit 302 outputs the decoded video to the display unit 303.

In S743, the display unit 303 displays the video input in S742 on the display 104.

In S744, when the video to be displayed is the overhead view video, the flow proceeds to S745. When the video to be displayed is not the overhead view video, the flow ends.

In S745, the second reception unit 304 receives the video from the transmission unit 408 of the display monitor camera. The second reception unit 304 outputs the received video to the second decoding unit 311.

In S746, the second decoding unit 311 decodes the video input in S745. The second decoding unit 311 outputs the decoded video to the synthesis unit 306.

In S747, the synthesis unit 306 obtains the position information on the monitor cameras C1-1, C1-2, C1-3, and C2-1 from the first management unit 308. The synthesis unit 306 obtains the map information from the second management unit 309. The synthesis unit 306 synthesizes the video input in S746 based on the obtained position information and map information. The synthesis unit 306 outputs the synthesized video to the display unit 303. When the display screen 501 on the left side of the example in FIG. 5 is created, the synthesis processing to the overhead view video of each of the monitor cameras C1-1, C1-2, C1-3, and C2-1 is performed. When the display screen 502 on the right side is created, the synthesis processing to the overhead view video of each of the monitor cameras C1-2 and C2-1 is performed.

In S748, the display unit 303 displays the video input in S747 on the display 104.

As described above, in the present embodiment, the monitor camera 400 performs processing for creating the overhead view video. Similarly to the first embodiment, when the overhead view video of the whole place P is displayed, the resolutions and the frame rates of the monitor cameras C1-1, C1-2, C1-3, and C2-1 are reduced. Therefore, the video can be transmitted to the display server 300 without compressing a network band. According to this, a system for providing video which looks down a whole place where it is necessary to place more than thousands of monitor cameras 400 such as a large shopping center, an amusement park, a platform of or a passage in a station can be constructed without introducing the control server 200 in the first embodiment.

Similarly to the first embodiment, in the present embodiment, when the overhead view video is enlarged, a targeted point is displayed, and the normal video is displayed, the resolutions and the frame rates of the monitor cameras 400 for imaging the region to be displayed are set to be high while stopping the outputs of the video of the monitor cameras 400 for imaging the regions which are not displayed. Therefore, a clearer image of the region where detailed monitoring is needed can be displayed on the display 104.

In the present embodiment, the video monitoring system 100 includes the first reception unit 301 and the second reception unit 304 in the display server 300 as a reception unit. Similarly to the first embodiment, the reception unit receives imaged video from a plurality of monitor cameras 400 (in the example in FIG. 5, the monitor cameras C1-1, C1-2, C1-3, and C2-1). Each monitor camera 400 images video of a corresponding region among a plurality of regions (in the example in FIG. 5, the imaging regions a to d) in a certain place P.

The video monitoring system 100 includes the display unit 303 and the synthesis unit 306 in the display server 300 as a control unit. Similarly to the first embodiment, the control unit performs control to display the video received by the reception unit on a screen (for example, the screen of the display 104).

The video monitoring system 100 includes the operation unit 307 in the display server 300. Similarly to the first embodiment, the operation unit 307 receives an operation (for example, the display control operation) for specifying a limited region (in the example of the enlarging instruction in FIG. 5, the imaging regions b and d) among the plurality of regions.

The video monitoring system 100 includes the first management unit 308, the second management unit 309, and the transmission unit 310 in the display server 300 as an instruction unit. Similarly to the first embodiment, when video of the plurality of regions is displayed on the screen by the control unit, the instruction unit instructs the plurality of monitor cameras 400 to transmit the imaged video in a first format. When video of the region specified to the operation unit 307 is displayed on the screen by the control unit, the instruction unit instructs a monitor camera 400 (in the example of the enlarging instruction in FIG. 5, the monitor cameras C1-2 and C2-1) which images the video of the specified region to transmit the imaged video in a second format. The second format has a larger data amount than the first format.

Similarly to the first embodiment, according to the present embodiment, by performing the above operations, the communication band necessary for transmitting the video imaged by the plurality of monitor cameras 400 can be reduced without disrupting video monitoring operation.

In the present embodiment, the reception unit receives overhead view video corresponding to video looking down the above-mentioned corresponding region from right above (for example, the overhead view video of each of the imaging regions a to d) from each of the plurality of monitor cameras 400.

When the video of the plurality of regions is displayed on the screen, the control unit creates overhead view video of the whole place P by synthesizing the overhead view video received by the reception unit and performs control to display the created overhead view video on the screen.

In the present embodiment, each of the plurality of monitor cameras 400 creates the overhead view video. Therefore, labor and costs to introduce the control servers 200 as in the first embodiment can be saved.

### Third Embodiment

Regarding the present embodiment, a difference from the second embodiment is mainly described.

The structure of a video monitoring system 100 according to the present embodiment is the same as that according to the second embodiment illustrated in FIG. 12.

In the second embodiment, a plurality of monitor cameras 400 converts view points of monitoring video. Whereas, in the present embodiment, in a case where overhead view video of a wide range is displayed, video in which an image of a person detected by each monitor camera 400 is overlapped with a background image is displayed instead of a camera image after view point conversion. This video is created based on metadata such as a position coordinate of the person detected by each monitor camera 400 and map information managed by a display server 300. By displaying such video, video monitoring with less load to a network can be performed.

In the present embodiment, each of monitor cameras C1-1, C1-2, . . . , and C1-m detects the person or the face of the person from the imaged video. Further, each of the monitor cameras C1-1, C1-2, . . . , and C1-m records video capturing the front of the face of the person or an angle closest to the front as a best shot image.

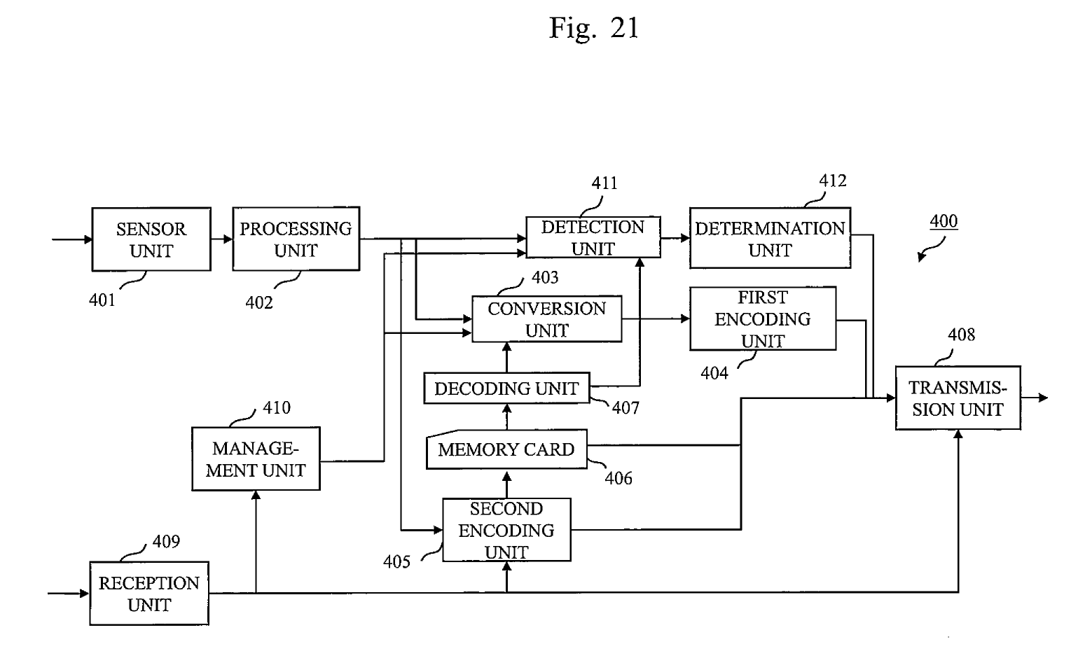

FIG. 21 is a block diagram of a structure of each monitor camera 400.

In FIG. 21, each monitor camera 400 includes a sensor unit 401, a processing unit 402, a conversion unit 403, a first encoding unit 404, a second encoding unit 405, a memory card 406, a decoding unit 407, a transmission unit 408, a reception unit 409, a management unit 410, a detection unit 411, and a determination unit 412. An operation of each unit is described below.

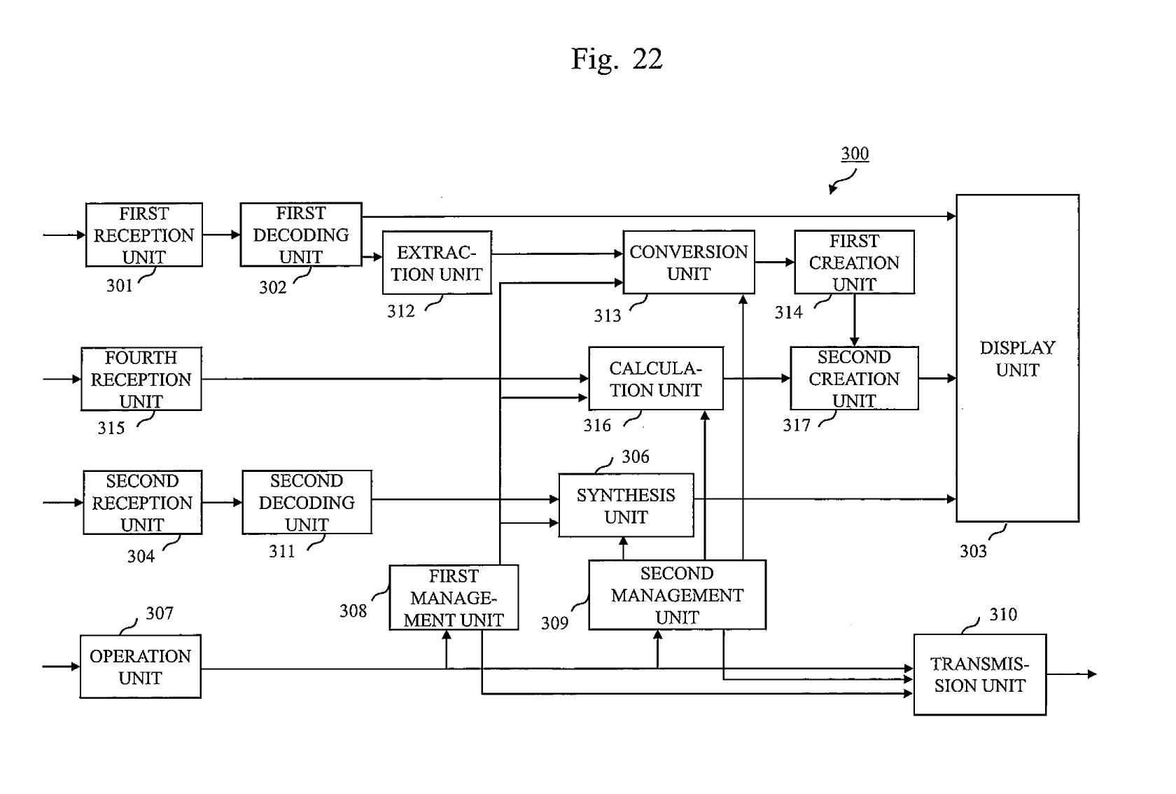

FIG. 22 is a block diagram of a structure of the display server 300.

In FIG. 22, the display server 300 includes a first reception unit 301, a first decoding unit 302, a display unit 303, a second reception unit 304, a synthesis unit 306, an operation unit 307, a first management unit 308, a second management unit 309, a transmission unit 310, a second decoding unit 311, an extraction unit 312, a conversion unit 313, a first creation unit 314, a fourth reception unit 315, a calculation unit 316, and a second creation unit 317. An operation of each unit is described below.

In the present embodiment, the video monitoring system 100 can be applied similarly to the example in FIG. 15.

A screen display of the display server 300 in the example in FIG. 15 is described below.

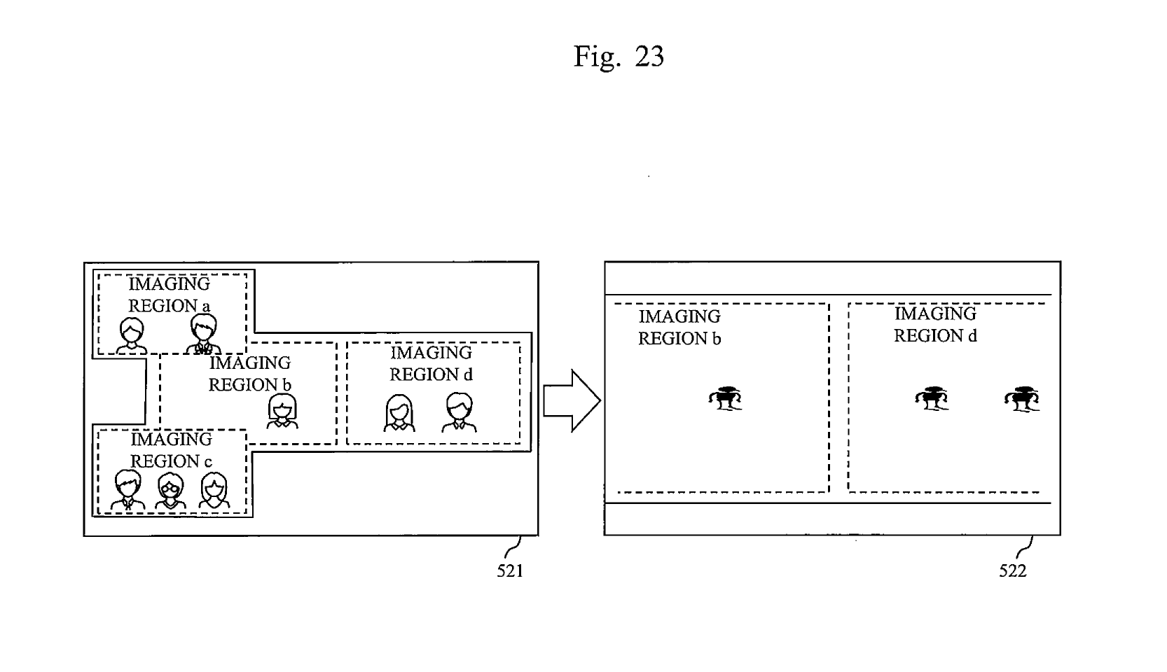

FIG. 23 is a diagram of an exemplary screen display of the display server 300.

In FIG. 23, a display screen 521 on the left side is overhead view video of a whole place P displayed on a display 104. When a monitoring person who constantly monitors monitoring video for security or the like issues an instruction to display the video of the whole by using a keyboard and a mouse 105 of the display server 300, overhead view video in which the face image of the person moving in the place P is overlapped with the background image of the place P (referred to as “background synthesizing video”) is created, and the created overhead view video is displayed on the screen.

A display screen 502 on the right side is overhead view video of the imaging regions b and d (partial) displayed on the display 104. When the monitoring person issues an instruction to enlarge and display the center of the display screen 501 (that is, enlarging instruction) by using the keyboard and the mouse 105 of the display server 300, the overhead view video of the imaging regions b and d obtained by converting the view points of the camera video (referred to as “view point conversion video” below) is displayed on the screen.

An operation of the video monitoring system 100 in the example in FIG. 15 (video monitoring method according to the present embodiment) is described below.

First, a camera control operation is described.

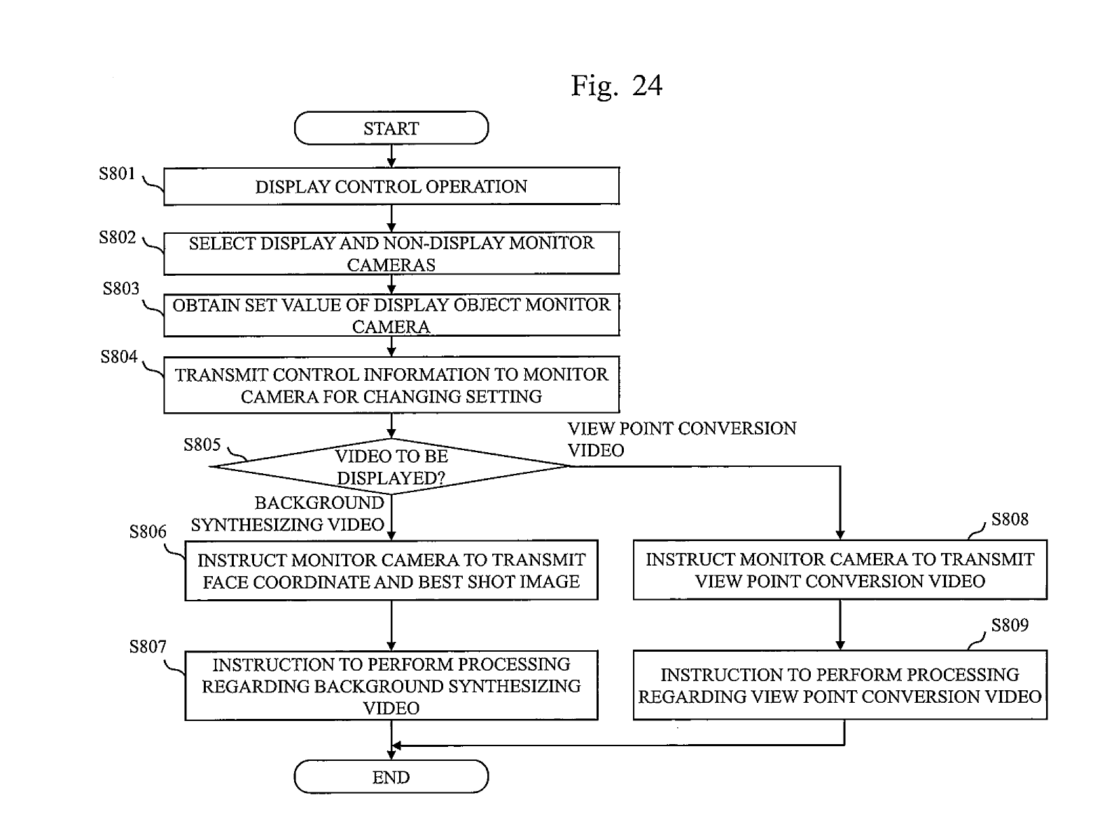

FIG. 24 is a flowchart of an exemplary operation of the display server 300 in a case where the monitoring person has issued the enlarging instruction or a targeting instruction of the displayed video.

In S801, the operation unit 307 receives an operation of the enlarging instruction or the targeting instruction as a display control operation from the monitoring person via the keyboard and the mouse 105. The operation unit 307 outputs the information on the imaging region to be displayed by the display control operation to the transmission unit 310. In the display control operation, it is assumed that any one of normal video, view point conversion video, and background synthesizing video can be selected as a kind of the video to be displayed on the display 104. When the video of the whole place P is displayed, it is preferable that the normal video cannot be selected. When the video of the whole place P is displayed, it is preferable that the view point conversion video cannot be selected. In the display control operation, since the range of the place P to be displayed is specified, the kinds of the video to be displayed may be automatically selected according to the specified range.

In S802, the transmission unit 310 obtains information on the monitor cameras C1-1, C1-2, C1-3, and C2-1 for respectively imaging the imaging regions a to d from the first management unit 308 and the second management unit 309. The transmission unit 310 selects the display monitor camera or the non-display monitor camera based on the information input in S801 and the information obtained from the first management unit 308 and the second management unit 309. In the example of the enlarging instruction in FIG. 23, the monitor cameras C1-1 and C1-3 for imaging the imaging regions a and c are non-display monitor cameras, and the monitor cameras C1-2 and C2-1 for imaging the imaging regions b and d are display monitor cameras.

In S803, the transmission unit 310 obtains the set value of the display monitor camera selected in S802 from the first management unit 308. In the example of the enlarging instruction in FIG. 23, in order to enlarge the video of the monitor cameras C1-2 and C2-1, the resolution and the frame rate of each of the monitor cameras C1-2 and C2-1 are set to be high.

In S804, the transmission unit 310 outputs the control information to the reception unit 409 of the monitor camera 400 of which setting change is needed. The control information includes information indicating that which one of the display and non-display monitor cameras is determined in S802 to be the monitor camera 400 which is a transmission destination and the set value obtained in S803. In the example of the enlarging instruction in FIG. 23, the control information indicating that the monitor camera C1-1 is the non-display monitor camera is transmitted to the monitor camera C1-1. Further, similar control information is transmitted to the monitor camera C1-3. The control information which indicates that the monitor camera C1-2 is the display monitor camera and specifies the resolution and the frame rate of the monitor camera C1-2 is transmitted to the monitor camera C1-2. Similar control information is transmitted to the monitor camera C2-1.

In S805, when the kind of the video selected in S801 is the background synthesizing video, the flow proceeds to S806. When the kind of the video selected in S801 is the view point conversion video, the flow proceeds to S808.

In S806, the transmission unit 310 outputs additional control information to the reception unit 409 of the monitor camera 400 of which the setting change is needed. The additional control information includes information for instructing to transmit a coordinate where the face of the person who is moving has been detected and a best shot image in which the face is best imaged.

In S807, the first management unit 308 instructs the conversion unit 313 and the calculation unit 316 to perform the processing and instructs the synthesis unit 306 to stop the processing.

In S808, the transmission unit 310 outputs additional control information to the reception unit 409 of the monitor camera 400 of which the setting change is needed. The additional control information includes information for instructing to transmit the view point conversion video.

In S809, the first management unit 308 instructs the synthesis unit 306 to perform the processing and instructs the conversion unit 313 and the calculation unit 316 to stop the processing.

Next, a camera setting operation is described.

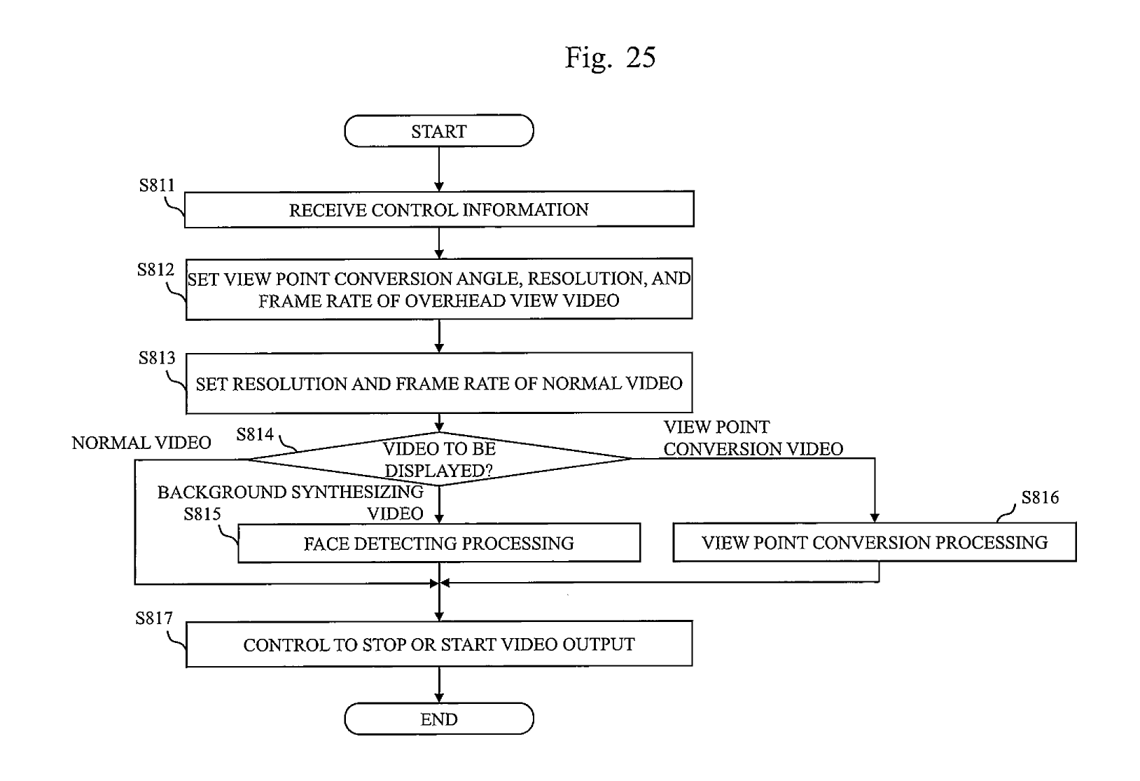

FIG. 25 is a flowchart of an exemplary operation of the monitor camera C1-2 in a case where the control information is transmitted from the display server 300.

In S811, the reception unit 409 receives the control information transmitted from the transmission unit 310 of the display server 300. The reception unit 409 outputs the received control information to the management unit 410. The control information includes information specified by the operation of the monitoring person and information which has been previously set. For example, the control information includes information indicating which one of live video and recorded video is displayed on the screen of the display 104. Information indicating whether the overhead view video of the whole place P is displayed, whether the overhead view video of a partial imaging region is enlarged and displayed, and whether normal video of the partial imaging region (that is, monitoring video before being converted to the overhead view video) is displayed is included. As the control information transmitted in S804, there is a case where the control information includes the information indicating which one of the display and non-display monitor cameras is the monitor camera 400 that is the transmission destination and the set value of the monitor camera 400 that is the transmission destination. There is a case where the control information includes the additional control information transmitted in S806 or S808.

In S812, the management unit 410 sets the point of view conversion angle, the resolution, and the frame rate of the overhead view video relative to the conversion unit 403 based on the control information input in S811. In the example of the enlarging instruction in FIG. 23, the resolution and the frame rate of the overhead view video are set to be high.

In S813, the reception unit 409 sets the resolution and the frame rate of the normal video relative to the second encoding unit 405 based on the control information received in S811.

In S814, the management unit 410 determines which one of the background synthesizing video, the view point conversion video, or the normal video the kind of the specified video is based on the control information input in S811. When the kind of the specified video is the background synthesizing video, the flow proceeds to S815. When the kind of the specified video is the view point conversion video, the flow proceeds to S816. When the kind of the specified video is the normal video, the flow proceeds to S817.

In S815, the management unit 410 instructs the detection unit 411 to perform face detecting processing. After that, the flow proceeds to S817.

In S816, the management unit 410 instructs the conversion unit 403 to perform view point conversion processing. After that, the flow proceeds to S817.

In S817, the reception unit 409 controls the transmission unit 408 so as to stop or start (or restart) the output of the video based on the control information received in S811. In the example of the enlarging instruction in FIG. 23, the output of the video starts.

The operation of each of the monitor cameras C1-1, C1-3, and C2-1 in a case where the control information is transmitted from the display server 300 is similar to that illustrated in FIG. 25. In the example of the enlarging instruction in FIG. 23, the outputs of the video from the monitor cameras C1-1 and C1-3 are stopped in S817, and the output of the video from the monitor camera C2-1 starts in S817.

Next, an operation for generating the overhead view video is described.

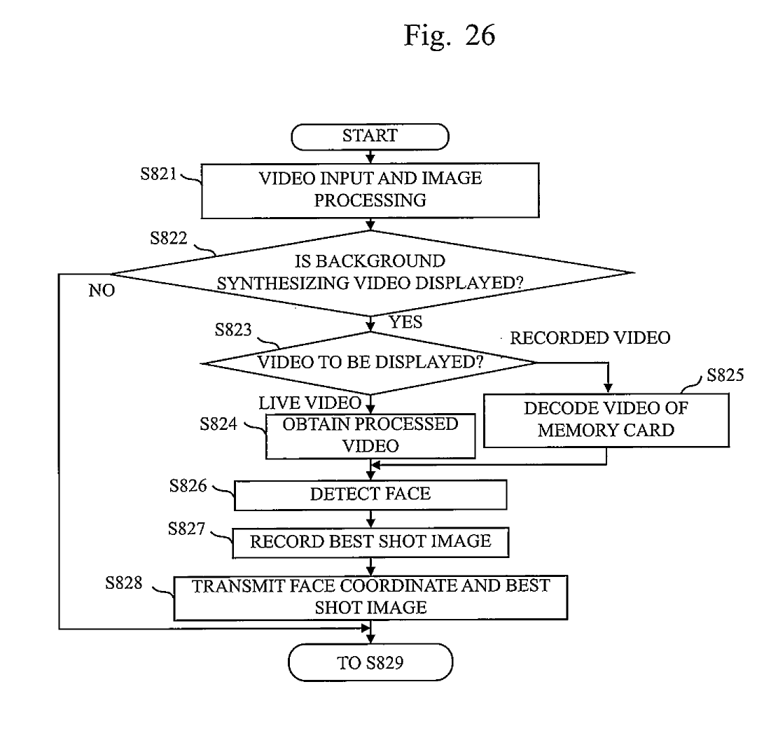

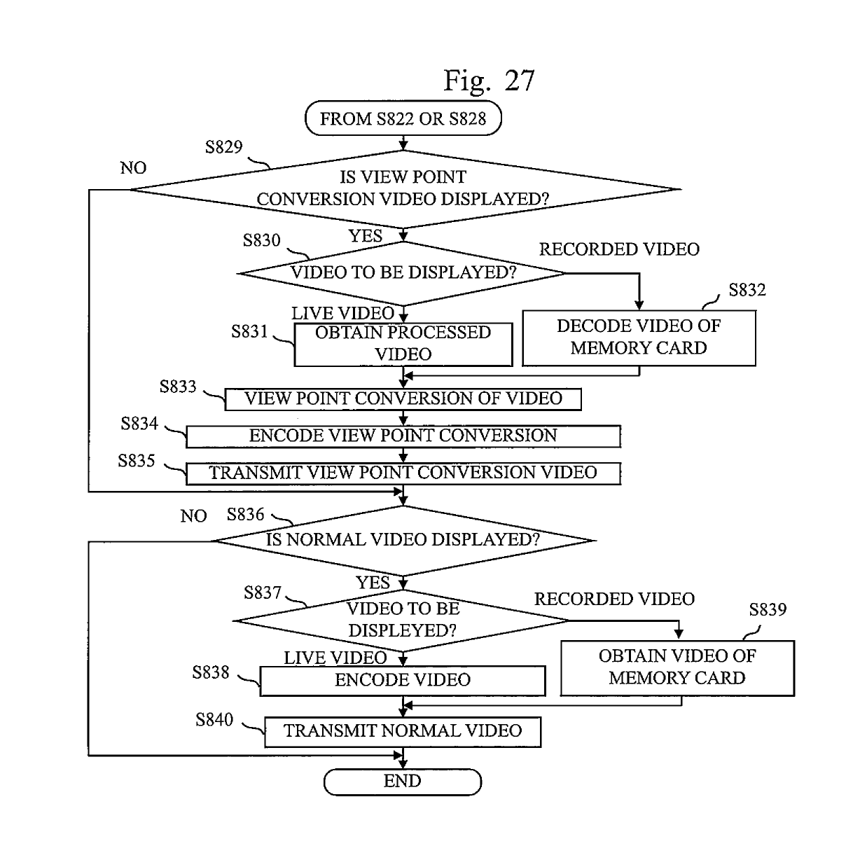

FIGS. 26 and 27 are flowcharts of an exemplary operation of the monitor camera C1-2 at the time of transmitting the video.

In S821, the sensor unit 401 images the video of the imaging region b by an image sensor. The sensor unit 401 outputs the imaged video to the processing unit 402. The processing unit 402 performs image processing such as noise elimination to the video input from the sensor unit 401.

In S822, the reception unit 409 determines whether the video to be displayed is the background synthesizing video based on the control information received in S811. When the video to be displayed is the background synthesizing video, the flow proceeds to S823. When the video to be displayed is not the background synthesizing video, the flow proceeds to S829.

In S823, the reception unit 409 switches the live video and the recorded video to be used based on the control information received in S811. When the video to be displayed is the live video, the flow proceeds to S824. When the video to be displayed is the recorded video, the flow proceeds to S825.

In S824, the detection unit 411 receives the input of the video processed in S821 from the processing unit 402. After that, the flow proceeds to S826.

In S825, the detection unit 411 obtains the video which has been read from the memory card 406 and decoded by the decoding unit 407. After that, the flow proceeds to S826.

In S826, the detection unit 411 detects the face of the person from the video obtained in S824 or S825 and outputs the coordinate of the face to the determination unit 412 together with image of the face.

In S827, the determination unit 412 records the image of the face input in S826 as the best shot image. After that, the determination unit 412 overwrites the recorded best shot image when the image is imaged at an angle closer to the front than the recorded best shot image every time when the image of the face is input in S826. The determination unit 412 outputs the coordinate of the face and the best shot image to the transmission unit 408.

In S828, the transmission unit 408 outputs the coordinate of the face and the best shot image input in S827 to the fourth reception unit 315 of the display server 300. In the example before the enlarging instruction in FIG. 23, the coordinate of the face of the person detected in the imaging region b and the best shot image are transmitted.

In S829, the reception unit 409 determines whether the video to be displayed is the view point conversion video based on the control information received in S811. When the video to be displayed is the view point conversion video, the flow proceeds to S830. When the video to be displayed is not the view point conversion video, the flow proceeds to S836.

In S830, the reception unit 409 switches the live video and the recorded video to be used based on the control information received in S811. When the video to be displayed is the live video, the flow proceeds to S831. When the video to be displayed is the recorded video, the flow proceeds to S832.

In S831, the conversion unit 403 receives the input of the video processed in S821 from the processing unit 402. After that, the flow proceeds to S833.

In S832, the conversion unit 403 obtains the video which has been read from the memory card 406 and decoded by the decoding unit 407. After that, the flow proceeds to S833.

In S833, the conversion unit 403 obtains the angle of view information on the monitor camera C1-2 from the management unit 410. The conversion unit 403 converts the view point of the video obtained in S831 or S832 based on the obtained angle of view information and creates the view point conversion video. The conversion unit 403 outputs the created view point conversion video to the first encoding unit 404.

In S834, the first encoding unit 404 encodes the view point conversion video input in S833. The first encoding unit 404 outputs the encoded view point conversion video to the transmission unit 408.

In S835, the transmission unit 408 outputs the view point conversion video input in S834 to the second reception unit 304 of the display server 300. In the example after the enlarging instruction in FIG. 23, the view point conversion video of the imaging region b is transmitted.

In S836, the reception unit 409 determines whether the video to be displayed is the normal video based on the control information received in S811. When the video to be displayed is the normal video, the flow proceeds to S837. When the video to be displayed is not the normal video, the flow ends.

In S837, the reception unit 409 switches the live video and the recorded video to be used based on the control information received in S811. When the video to be displayed is the live video, the flow proceeds to S838. When the video to be displayed is the recorded video, the flow proceeds to S839.

In S838, the second encoding unit 405 receives the input of the video processed in S821 from the processing unit 402. The second encoding unit 405 encodes the input video. The second encoding unit 405 outputs the encoded video to the transmission unit 408. After that, the flow proceeds to S840.

In S839, the transmission unit 408 obtains the video from the memory card 406. After that, the flow proceeds to S840.

In S840, the transmission unit 408 outputs the video obtained in S838 or S839 to the first reception unit 301 of the display server 300.

The operation of each of the monitor cameras C1-1, C1-3, and C2-1 at the time of transmitting the video is similar to those illustrated in FIGS. 26 and 27. When the display screen 521 on the left side of the example in FIG. 23 is created, the coordinate of the face of the person detected in each of the imaging regions a, c, and d and the best shot image are transmitted in S828 from each of the monitor cameras C1-1, C1-3, and C2-1. When the display screen 522 on the right side is created, the view point conversion video of the imaging region d is transmitted from the monitor camera C2-1 in S835, and the view point conversion video of the imaging regions a and c is not transmitted.

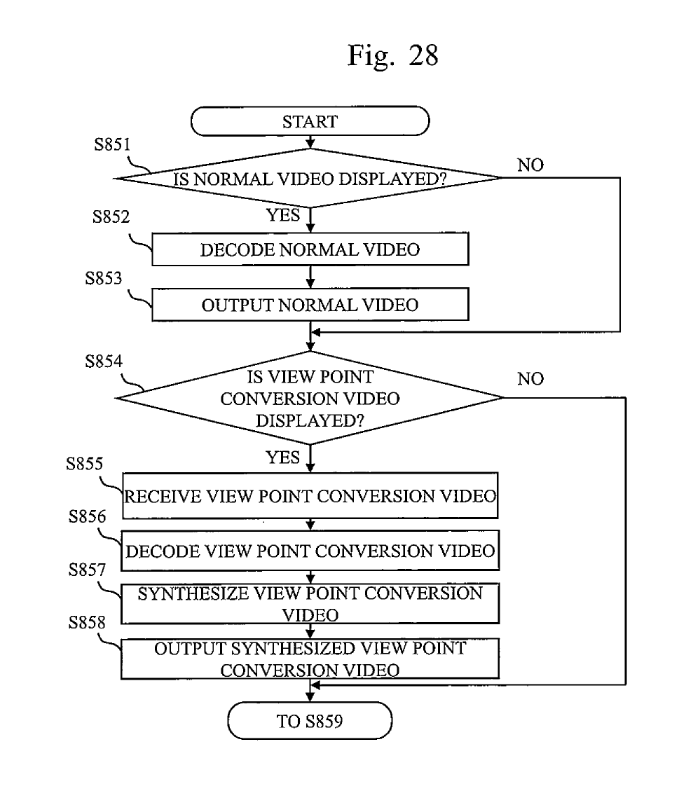

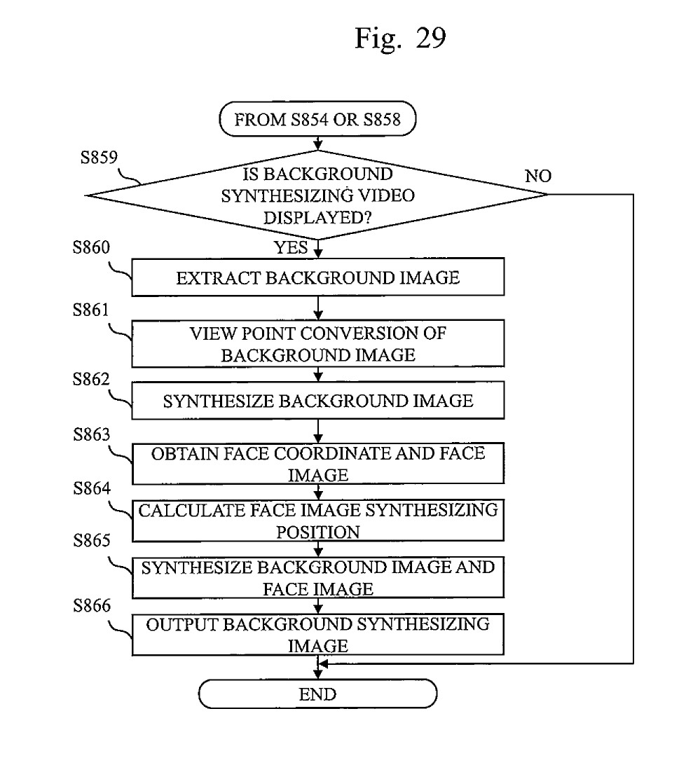

FIGS. 28 and 29 are flowcharts of an exemplary operation of the display server 300 when the video is transmitted from the display monitor camera.

In S851, when the video to be displayed is the normal video, the first reception unit 301 receives the video from the transmission unit 408 of the display monitor camera. The first reception unit 301 outputs the received video to the first decoding unit 302. After that, the flow proceeds to S852. When the video to be displayed is not the normal video, the flow proceeds to S854.

In S852, the first decoding unit 302 decodes the video input in S851. The first decoding unit 302 outputs the decoded video to the display unit 303.

In S853, the display unit 303 displays the video input in S852 on the display 104.

In S854, when the video to be displayed is the view point conversion video, the flow proceeds to S855. When the video to be displayed is not the view point conversion video, the flow proceeds to S859.

In S855, the second reception unit 304 receives the video from the transmission unit 408 of the display monitor camera. The second reception unit 304 outputs the received video to the second decoding unit 311.

In S856, the second decoding unit 311 decodes the video input in S855. The second decoding unit 311 outputs the decoded video to the synthesis unit 306.

In S857, the synthesis unit 306 obtains the position information on the monitor cameras C1-1, C1-2, C1-3, and C2-1 from the first management unit 308. The synthesis unit 306 obtains the map information from the second management unit 309. The synthesis unit 306 synthesizes the video input in S856 based on the obtained position information and map information. The synthesis unit 306 outputs the synthesized video to the display unit 303. When the display screen 522 on the right side of the example in FIG. 23 is created, the synthesis processing to the view point conversion video of each of the monitor cameras C1-2 and C2-1 is performed.

In S858, the display unit 303 displays the video input in S857 on the display 104.

In S859, when the video to be displayed is the background synthesizing video, the flow proceeds to S860. When the video to be displayed is not the background synthesizing video, the flow ends.

In S860, the extraction unit 312 receives the input of the normal video of each of the monitor cameras C1-1, C1-2, C1-3, and C2-1 (or monitor camera 400 corresponding to the display range) from the first decoding unit 302. The extraction unit 312 removes a changed part (that is, a difference) of the input normal video from the past and extracts the background image. The extraction unit 312 outputs the extracted background image to the conversion unit 313.

In S861, the conversion unit 313 obtains the position information on the monitor cameras C1-1, C1-2, C1-3, and C2-1 from the first management unit 308. The conversion unit 313 obtains the map information from the second management unit 309. The conversion unit 313 converts the view point of the background image input in S860 based on the obtained position information and map information. The conversion unit 313 outputs the background image after the view point conversion to the first creation unit 314.

In S862, the first creation unit 314 synthesizes the background images of the monitor cameras C1-1, C1-2, C1-3, and C2-1 input in S861 and creates the background image of the whole place P. The first creation unit 314 outputs the created background image to the second creation unit 317.

In S863, the fourth reception unit 315 receives the coordinate of the face and the best shot image from the transmission unit 408 of each of the monitor cameras C1-1, C1-2, C1-3, and C2-1. The fourth reception unit 315 outputs the received coordinate of the face and best shot image to the calculation unit 316.

In S864, the calculation unit 316 obtains the position information on the monitor cameras C1-1, C1-2, C1-3, and C2-1 from the first management unit 308. The calculation unit 316 obtains the map information from the second management unit 309. The calculation unit 316 calculates a coordinate where the best shot image is overlapped with the background image from the coordinate of the face input in S863 based on the obtained position information and map information. The calculation unit 316 outputs the calculated coordinate and the best shot image input in S863 to the second creation unit 317.

In S865, the second creation unit 317 synthesizes the coordinate input in S864 with the best shot image input in S864 in the background image of the whole place P input in S862 and creates the background synthesizing video. The second creation unit 317 outputs the created background synthesizing video to the display unit 303. When the display screen 521 on the left side of the example in FIG. 23 is created, the background synthesizing video of the whole place P is created.

In S866, the display unit 303 displays the video input in S865 on the display 104.

As described above, in the present embodiment, when the overhead view video of the whole place P is displayed, the video of the monitor cameras C1-1, C1-2, C1-3, and C2-1 is not output, and video in which the best shot of the face is displayed at the position of the person (or face) detected by the image processing in a camera is output. Therefore, a use rate of the network band can be remarkably reduced. According to this, a system for providing video for looking down the whole place where it is necessary to place more than thousands of monitor cameras can be constructed.

In the present embodiment, similarly to the second embodiment, when the overhead view video is enlarged, a targeted point is displayed, and the normal video is displayed, the resolutions and the frame rates of the monitor cameras 400 for imaging the region to be displayed are set to be high while stopping the outputs of the video of the monitor cameras 400 for imaging the region which is not displayed. Therefore, a clearer image of the region where detailed monitoring is needed can be displayed on the display 104.

In the present embodiment, the video monitoring system 100 includes the first reception unit 301, the second reception unit 304, and the fourth reception unit 315 in the display server 300 as a reception unit. Similarly to the second embodiment, the reception unit receives imaged video from a plurality of monitor cameras 400 (in the example in FIG. 23, the monitor cameras C1-1, C1-2, C1-3, and C2-1). Each monitor camera 400 images video of a corresponding region among a plurality of regions (in the example in FIG. 23, the imaging regions a to d) in a certain place P. Further, the reception unit receives information indicating a position of a person in the place P from the plurality of monitor cameras 400.

The video monitoring system 100 includes the extraction unit 312, the conversion unit 313, and the first creation unit 314 in the display server 300 as a generation unit. The generation unit generates a background image corresponding to an image of the whole place P obtained by removing the person in the place P from the video received by the reception unit.

The video monitoring system 100 includes the display unit 303 and the synthesis unit 306 in the display server 300 as a control unit. When the video of the plurality of regions is displayed on a screen (for example, the screen of the display 104), the control unit creates video in which an identification image for identifying the person in the place P is overlapped with the position indicated by the information received by the reception unit in the background image generated by the generation unit and performs control to display the created video on the screen.

According to the present embodiment, by performing the above operations, the communication band necessary for transmitting the video imaged by the plurality of monitor cameras 400 can be more reduced.

In the present embodiment, the reception unit receives the information indicating the position of the person in the place P from the plurality of monitor cameras 400. However, the calculation unit 316 of the display server 300 may calculate the position of the person in the place P from the video received by the reception unit. In this way, when the video of the plurality of regions is displayed on the screen, the control unit can create video in which the identification image for identifying the person in the place P is overlapped with the position calculated by the calculation unit 316 in the background image generated by the generation unit.

In the present embodiment, the reception unit receives an image of the face of the person in the place P from the plurality of monitor cameras 400 as the identification image. However, the control unit may extract an image of the face of the person in the place P from the video received by the reception unit as the identification image.

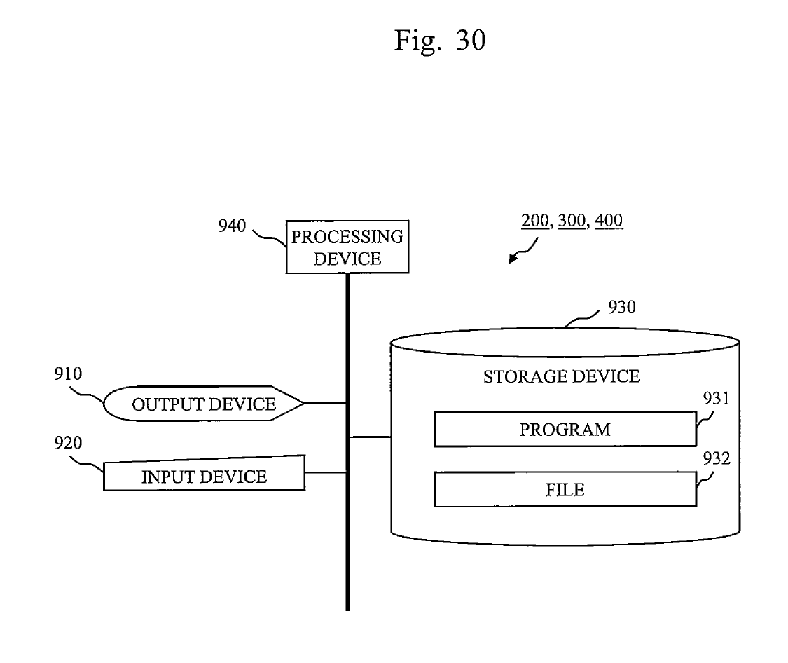

FIG. 30 is a diagram of an exemplary hardware structure of each device of the video monitoring system 100 (that is, the monitor camera 101, the control server 200, and the display server 300) according to the embodiments of the present invention.

In FIG. 30, all or a part of the devices of the video monitoring system 100 are computers. Each device includes hardware such as an output device 910, an input device 920, a storage device 930, and a processing device 940. The hardware is used by each unit of each device (the one descried as the “unit” in the embodiments of the present invention).

For example, the output device 910 is a display device such as a liquid crystal display (LCD), a printer, and a communication module (such as a communication circuit). The output device 910 is used to output (transmit) data, information, and a signal by the one described as the “unit” in the embodiments of the present invention. The display 104 is an example of the output device 910.

For example, the input device 920 is a keyboard, a mouse, a touch panel, and a communication module (such as a communication circuit). The input device 920 is used to input (receive) the data, the information, and the signal by the one described as the “unit” in the embodiments of the present invention. The keyboard and the mouse 105 are examples of the input device 920. In a case where the display 104 is the touch panel, the display 104 is also an example of the input device 920.

For example, the storage device 930 is a read only memory (ROM), a random access memory (RAM), a hard disk drive (HDD), and a solid state drive (SSD). The storage device 930 stores a program 931 and a file 932. The program 931 includes a program for performing the processing (function) of the one described as the “unit” in the embodiments of the present invention. The file 932 includes data, information, a signal (value), and the like calculated, processed, read, written, used, input, and output by the one described as the “unit” in the embodiments of the present invention. The hard disk 203 (or the recording medium) and the memory card 406 are examples of the storage device 930.

For example, the processing device 940 is a central processing unit (CPU). The processing device 940 is connected to other hardware devices via a bus and the like and controls the hardware devices. The processing device 940 reads the program 931 from the storage device 930 and executes the program 931. The processing device 940 is used to calculate, process, read, write, use, input, and output by the one described as the “unit” in the embodiments of the present invention.

The one described as the “unit” in the embodiments of the present invention may be the one described as a “circuit”, a “device”, and an “apparatus” instead of the “unit”. Further, the one described as the “unit” in the embodiments of the present invention may be the one described as “process”, a “procedure”, and “processing” instead of the “unit”. That is, the one described as the “unit” in the embodiments of the present invention is realized by software, hardware, or a combination of the software and the hardware. The software is stored in the storage device 930 as the program 931. The program 931 makes the computer function as the one described as the “unit” in the embodiments of the present invention. Alternatively, the program 931 makes the computer perform processing to the one described as the “unit” in the embodiments of the present invention.

The embodiments of the present invention have been described above. Some of the embodiments may be combined. Alternatively, any one or some of the embodiments may be partially executed. For example, any one of the ones described as the “unit” in the description of the embodiments may be employed, or any optional combinations of some of the ones may be employed. The present invention is not limited to the embodiments and can be variously changed as necessary.

### REFERENCE SIGNS LIST

100: video monitoring system, 101: monitor camera, 102: LAN, 103: LAN, 104: display, 105: keyboard and mouse, 106: network device, 200: control server, 201: first reception unit, 202: second reception unit, 203: hard disk, 204: switching unit, 205: first transmission unit, 206: decoding unit, 207: generation unit, 208: second transmission unit, 209: synthesis unit, 210: third transmission unit, 211: third reception unit, 212: management unit, 213: output unit, 300: display server, 301: first reception unit, 302: first decoding unit, 303: display unit, 304: second reception unit, 305: third reception unit, 306: synthesis unit, 307: operation unit, 308: first management unit, 309: second management unit, 310: transmission unit, 311: second decoding unit, 312: extraction unit, 313: conversion unit, 314: first creation unit, 315: fourth reception unit, 316: calculation unit, 317: second creation unit, 400: monitor camera, 401: sensor unit, 402: processing unit, 403: conversion unit, 404: first encoding unit, 405: second encoding unit, 406: memory card, 407: decoding unit, 408: transmission unit, 409: reception unit, 410: management unit, 411: detection unit, 412: determination unit, 501: display screen, 502: display screen, 511: display screen, 512: targeted area, 513: display screen, 521: display screen, 522: display screen, 910: output device, 920: input device, 930: storage device, 931: program, 932: file, and 940: processing device

1-10. (canceled)

11. A video monitoring system comprising:
a reception unit to receive imaged video from a plurality of monitor cameras, each of which images video of a corresponding region among a plurality of regions in a certain place;
a control unit to perform control to display the video received by the reception unit on a screen;
an operation unit to receive an operation for specifying a limited region among the plurality of regions; and
an instruction unit to instruct the plurality of monitor cameras to transmit the imaged video in a first format when video of the plurality of regions is displayed on the screen by the control unit and instruct a monitor camera which images video of the region specified to the operation unit to transmit the imaged video in a second format which has a larger data amount than the first format when the video of the specified region is displayed on the screen by the control unit, wherein
when the video of the plurality of regions is displayed on the screen by the control unit, overhead view video of a whole of the place is created by synthesizing overhead view video corresponding to video looking down the corresponding region from right above and control to display the created overhead view video on the screen is performed.

12. The video monitoring system according to claim 11, further comprising:
a generation unit to convert the video received from each of the plurality of monitor cameras by the reception unit and generate the overhead view video of the corresponding region, wherein
when the video of the plurality of regions is displayed on the screen by the control unit, the overhead view video of the whole of the place is created by synthesizing the overhead view video generated by the generation unit.

13. The video monitoring system according to claim 11, wherein
the reception unit receives the overhead view video of the corresponding region from each of the plurality of monitor cameras, and
when the video of the plurality of regions is displayed on the screen by the control unit, the overhead view video of the whole of the place is created by synthesizing the overhead view video received by the reception unit.

14. The video monitoring system according to claim 11, further comprising:
a generation unit to extract, from the video received by the reception unit, a background image corresponding to an image of the corresponding region obtained by removing a person in the corresponding region, generate the overhead view video of the corresponding region by converting the extracted background image, and generate a background image corresponding to an image of the whole of the place obtained by removing a person in the place, by synthesizing the overhead view video of the corresponding region, wherein
the reception unit receives information indicating a position of the person in the place from the plurality of monitor cameras, and
when the video of the plurality of regions is displayed on the screen by the control unit, the overhead view video of the whole of the place is created by overlapping an identification image for identifying the person in the place with the position indicated by the information received by the reception unit in the background image generated by the generation unit.

15. The video monitoring system according to claim 11, further comprising:
a calculation unit to calculate a position of a person in the place from the video received by the reception unit; and
a generation unit to extract, from the video received by the reception unit, a background image corresponding to an image of the corresponding region obtained by removing a person in the corresponding region, generate the overhead view video of the corresponding region by converting the extracted background image, and generate a background image corresponding to an image of the whole of the place obtained by removing the person in the place, by synthesizing the overhead view video of the corresponding region, wherein
when the video of the plurality of regions is displayed on the screen by the control unit, the overhead view video of the whole of the place is created by overlapping an identification image for identifying the person in the place with the position calculated by the calculation unit in the background image generated by the generation unit.

16. The video monitoring system according to claim 14, wherein
the reception unit receives an image of a face of the person in the place from the plurality of monitor cameras as the identification image.

17. The video monitoring system according to claim 14, wherein
the control unit extracts an image of a face of the person in the place from the video received by the reception unit as the identification image.

18. The video monitoring system according to claim 11, wherein
when the video of the region specified to the operation unit is displayed on the screen by the control unit, the instruction unit instructs a monitor camera other than the monitor camera which images the video of the specified region among the plurality of monitor cameras not to transmit the imaged video.

19. The video monitoring system according to claim 11, wherein
at least one of resolution and frame rate of the video transmitted in the first format is lower than that of the video transmitted in the second format.

20. A video monitoring method comprising:
receiving, by a computer, imaged video from a plurality of monitor cameras, each of which images video of a corresponding region among a plurality of regions in a certain place;
performing, by the computer, control to display the received video on a screen;
receiving, by the computer, an operation for specifying a limited region among the plurality of regions; and
when video of the plurality of regions is displayed on the screen, instructing, by the computer, the plurality of monitor cameras to transmit the imaged video in a first format, and when video of the region specified by the operation is displayed on the screen, instructing, by the computer, a monitor camera which images the video of the specified region to transmit the imaged video in a second format which has a larger data amount than the first format, wherein
when the video of the plurality of regions is displayed on the screen, overhead view video of a whole of the place is created by synthesizing overhead view video corresponding to video looking down the corresponding region from right above and control to display the created overhead view video on the screen is performed.

21. The video monitoring system according to claim 15, wherein
the reception unit receives an image of a face of the person in the place from the plurality of monitor cameras as the identification image.

22. The video monitoring system according to claim 15, wherein
the control unit extracts an image of a face of the person in the place from the video received by the reception unit as the identification image.
